(19) United States
(12) Patent Application Publication
(10) Pub. No.: US 2018/0029003 A1
(43) Pub. Date: Feb. 1, 2018

(54) SYSTEMS, METHODS, AND APPARATUSES FOR FISCHER-TROPSCH REACTOR CASCADE

(71) Applicant: SGC Energia Co., LLC, Pasadena, TX (US)

(72) Inventors: Juan R. Inga, Houston, TX (US); John Hemmings, Houston, TX (US); Leo Bonnell, Houston, TX (US)

(21) Appl. No.: 15/551,058

(22) PCT Filed: Feb. 24, 2016
(86) PCT No.: PCT/US16/19402

§ 371 Date: Aug. 15, 2017

Related U.S. Application Data
(60) Provisional application No. 62/120,746, filed on Feb. 25, 2015.

(51) Int. Cl. B01J 19/24; C10G 2/00; B01J 19/00; B01J 8/02; B01J 8/06

(52) U.S. Cl. CPC B01J 19/245; B01J 8/0278; B01J 8/0285; B01J 8/065; B01J 8/067; B01J 19/0093; C10G 2/341; B01J 2208/065; B01J 2219/00781

(57) ABSTRACT

Methods, systems and apparatuses are disclosed for a Fischer-Tropsch (“FT”) operation including a first FT stage comprising at least one FT reactor having a first FT catalyst and a first heat transfer surface area to catalyst volume configured to receive a first feed comprising synthesis gas and to convert a first portion of the synthesis gas in the first feed into first FT products. The disclosure also provides for a separation apparatus configured to separate the first FT products into first liquid FT hydrocarbons and first FT tail gas comprising unreacted syngas and for a second FT stage comprising at least one second FT reactor, having a second FT catalyst and a second heat transfer surface area to catalyst volume different from the first heat transfer surface area to catalyst volume, and configured to receive a second feed comprising the first FT tail gas and to convert at least a portion of the second feed into a second FT products.

### STATEMENT REGARDING FEDERALLY SPONSORED RESEARCH OR DEVELOPMENT

Not applicable.

### BACKGROUND

### Field of the Disclosure

This disclosure relates to systems and methods for producing Fischer-Tropsch hydrocarbons via a Fischer-Tropsch reactor cascade. More particularly, this disclosure relates to the production of Fischer-Tropsch hydrocarbons via a Fischer-Tropsch reactor cascade comprising at least one first Fischer-Tropsch reactor in fluid communication with at least one second Fischer-Tropsch reactor, wherein the at least one first Fischer-Tropsch reactor has a heat transfer surface area to catalyst volume ratio that is either less than or greater than that of the at least one second Fischer-Tropsch reactor.

### Background of the Disclosure

The Fischer-Tropsch process was developed as a way of producing hydrocarbons from coal, natural gas, biomass, and the like. The formation of valuable products from natural gas (which may comprise primarily methane), coal, biomass, and other hydrocarbonaceous sources typically incorporates an intermediate step that entails the conversion of the hydrocarbonaceous source to synthesis gas or ‘syngas’, which is a mixture comprising carbon monoxide and hydrogen. The Fischer-Tropsch (or ‘FT’) process is a catalytic and exothermic process that is utilized to produce petroleum substitutes, typically gasoline-range boiling hydrocarbons used as automotive fuels. More recently, Fischer-Tropsch is increasingly being used as a method for preparing heavier hydrocarbons, such as diesel fuels, and waxy molecules that may subsequently be converted into desirable products, such as, but not limited to, lubricants.

The Fischer-Tropsch process involves a series of chemical reactions that produce a variety of hydrocarbons. FT reactions produce alkanes, for example, via the simplistically expressed Equation (1):

(2n+1)H₂+nCO→CₙH₂ₙ₊₂+nH₂O, (1)

where ‘n’ is a positive integer. Thus, typical FT reaction products include paraffins, represented by the formula CₙH₂ₙ₊₂, where n (i.e., the average carbon number of the product) is determined by reaction conditions including, but not limited to, temperature, pressure, space velocity, catalyst type, and feed stream composition. The formation of methane (i.e., n=1) is generally undesirable. A majority of the alkanes produced via the Fischer-Tropsch synthesis are straight-chain alkanes, although branched alkanes are also formed. In addition to alkane formation, competing reactions result in the formation of alkenes, as well as alcohols and other oxygenated hydrocarbons. In applications, relatively small quantities of non-alkane products are formed, although catalysts favoring some of these products have been developed.

A variety of catalysts can be used for the Fischer-Tropsch process, with the most common comprising the transition metals cobalt, and iron. Also useful are exotic metals like ruthenium. Nickel may be employed; however, nickel-based catalysts tend to favor the formation of methane, which is also known as ‘methanation’. Bimetallic Fischer-Tropsch catalysts, such as nickel-iron (e.g., Fe₃Ni, FeNi₃), cobalt-ruthenium, cobalt-platinum, cobalt-palladium, and the like, are also known in the art.

Cobalt-based catalysts are highly active, although iron-based Fischer-Tropsch catalysts are generally considered to be more suitable for low-hydrogen-content synthesis gases, such as those derived from coal, due to the tendency of iron-based catalysts to promote the water-gas-shift reaction (also referred to herein as the ‘WGSR’). In addition to the active metal or metals, Fischer-Tropsch catalysts typically contain a number of ‘promoters’, including, but not limited to, potassium and copper. Group 1 alkali metals, such as potassium, are typically considered to be a poison for cobalt catalysts, while being a promoter for iron catalysts. Fischer-Tropsch catalysts are often supported on high-surface-area binders/supports such as silica, alumina, titania, and zeolites.

As noted hereinabove, iron-based catalysts promote a water-gas-shift, which provides additional hydrogen via the reaction of Equation (2):

H₂O+CO→H₂+CO₂ (2)

Accordingly, iron-based Fischer-Tropsch catalysts can generally tolerate feed streams comprising significantly lower molar ratios of hydrogen to carbon monoxide than can catalysts that do not promote or do not so highly promote the water-gas shift reaction (e.g., cobalt-based catalysts). This reactivity can be important for applications in which the synthesis gas for Fischer-Tropsch synthesis is derived from coal and/or biomass. Such synthesis gas tends to have relatively low molar ratios of hydrogen to carbon monoxide (e.g., less than or equal to about 1). Cobalt catalysts are typically more active for Fischer-Tropsch synthesis when the molar ratio of hydrogen to carbon monoxide in the feed synthesis gas is higher, such as when the feedstock synthesis gas is derived from natural gas. Synthesis gas produced from natural gas tends to comprise a higher molar ratio of hydrogen to carbon monoxide than the stoichiometric ratio of 2.1, so the water-gas-shift is typically not needed to enhance the molar ratio of such synthesis gas for use with cobalt-based catalysts. Iron-based catalysts are thus often preferred over cobalt-based catalysts for application with lower quality feedstocks, such as synthesis gas produced from coal and/or biomass.

Fischer-Tropsch catalysts deactivate by a variety of mechanisms. Catalyst deactivation and poisoning are caused by many factors, including, for example, undesired reaction of the active metal (e.g., reaction with sulfur). While, as a result of the water-gas-shift reaction, iron catalysts are generally preferred for use with lower quality feedstocks, these catalysts tend to form a number of undesirable products, including various oxides and carbides, and are well known to produce undesirably large amounts of carbon dioxide (e.g., via water-gas shift).

The utility of FT catalysts is decreased if they exhibit high methanation activity during FT synthesis. High levels of catalytic methane formation from carbon monoxide and hydrogen decreases the utility of a FT catalyst for formation of higher hydrocarbons. For example, the utility, as a Fischer-Tropsch catalyst, of nickel on conventional metal oxide supports is decreased as a result of the high methanation activity typical of nickel-based Fischer-Tropsch catalysts.

Cobalt-based catalysts are highly active, and, as mentioned hereinabove, are especially useful when the feedstock is formed from natural gas. Because of a high molar ratio of hydrogen to carbon monoxide typical of such feedstocks, water-gas-shift is not needed therewith. However, some feedstocks tend to also include sulfur-based components, and the sensitivity of the catalyst to sulfur may be significantly enhanced for cobalt-based catalysts relative to their iron counterparts, as cobalt-based Fischer-Tropsch catalysts often strongly adsorb sulfur. Furthermore, the cost of a cobalt-based catalyst may be more than ten times the cost of an iron-based catalyst. In extreme instances, virtually every atom of sulfur that enters the reactor may attach to a catalytically active site on a cobalt-based catalyst and poison it.

Techniques for removing sulfur from feedstock gas upstream of FT reactor(s) are known, and typically include the use of a vessel loaded with zinc oxide (or other suitable component/support). However, these systems require considerable external pressure loading and are expensive as a result of necessary compressor equipment, raw materials, and utilities.

Accordingly, there are needs in the art for enhanced systems and methods for the production of Fischer-Tropsch hydrocarbons. There are needs in the art for systems and methods to desirably provide for effective and economical reduction of the concentration of sulfur-based components and/or other impurities in a FT feed stream, whereby the lifetime of the FT catalyst can be extended. Desirably, such systems and methods provide for the affordable removal of sulfur and/or other impurities, thus enhancing the lifetime of the Fischer-Tropsch catalyst, and/or enhancing the productivity, activity, and/or selectivity thereof. In other situations, the synthesis gas used as a feed contains a very low concentration of sulfur compounds and other poisons and consequently there is less concern with catalyst poisoning and more concern with, and needs in the art to address, optimal catalyst utilization. There are also needs in the art for enhanced systems and methods to address situations wherein the synthesis feed gas has a high combined partial pressure of hydrogen and carbon monoxide.

### SUMMARY

There are disclosed herein one or more embodiments for a Fischer-Tropsch (“FT”) reactor system that includes a first FT reactor having a first FT catalyst and a first heat transfer surface area to catalyst volume ratio and being configured to receive a first feed comprising synthesis gas and, operating at first FT conditions, to convert a first portion of the synthesis gas in the first feed into first FT products, leaving unconverted a second portion of the synthesis gas. The first FT products comprise FT hydrocarbons. The FT reactor system includes a first separation apparatus configured to receive the first FT products as at least part of its feed and to separate the first FT products into first liquid FT hydrocarbons and a first FT tail gas stream comprising unreacted syngas. The FT reactor system further includes a second FT reactor, having a second FT catalyst and a second heat transfer surface area to catalyst volume ratio that is different from the first heat transfer surface area to catalyst volume ratio, in series with the first FT reactor. The second FT reactor is configured to receive a second feed comprising the first FT tail gas stream and, operating at second FT conditions, to convert at least a portion of the second feed into second FT products comprising second liquid FT hydrocarbons and a second FT tail gas stream.

The present disclosure also includes one or more embodiments of methods of producing FT hydrocarbons that includes the steps of introducing a first syngas feed comprising carbon monoxide and hydrogen into a first FT reactor having a first FT catalyst and a first heat transfer surface area to catalyst volume ratio, operating the first FT reactor at first FT operating conditions to convert a first portion of the syngas in the first syngas feed to FT product hydrocarbons, leaving a second portion of the syngas in the first syngas feed unconverted, separating the second portion of the syngas from liquid FT product hydrocarbons; introducing a second syngas feed comprising hydrogen and carbon monoxide and including the second portion of the syngas into a second FT reactor having a second FT catalyst and a second heat transfer surface area to catalyst volume ratio that is different from the first heat transfer surface area to catalyst volume ratio; operating the second FT reactor at second FT operating conditions to convert at least a portion of the syngas in the second feed to FT product hydrocarbons.

The present disclosure also includes one or more embodiments of methods of producing FT hydrocarbons that includes the steps of providing a carbonaceous source feed and converting the carbonaceous source feed to a first syngas feed, conditioning the first syngas feed into a first fresh syngas feed, forming at least a portion of a first FT feed, adjusting the temperature of the first FT feed, introducing the first FT feed into a first FT reactor stage comprising one or a plurality of FT reactors each having a first FT catalyst and a first heat transfer surface area to catalyst volume ratio; producing first FT hydrocarbon products in the first FT reactor stage operating under first FT operating conditions; separating the first FT hydrocarbon products into first liquid FT products and a first gas FT product stream; recycling a first portion of the first gas FT product stream as a portion of the first feed; using a second portion of the first gas FT product stream as at least part of a second FT feed; adjusting the temperature of the second FT feed; introducing the second FT feed having the adjusted temperature to a second FT reactor stage comprising one or a plurality of FT reactors each having a second FT catalyst and a second heat transfer surface area to catalyst volume ratio wherein a first ratio of the combined heat transfer surface area of all of the first FT reactors of the first FT reactor stage divided by the total combined catalyst volume of all of the first FT reactors of the first FT reactor stage differs from a second ratio of the combined heat transfer surface area of all of the second FT reactors of the second FT reactor stage divided by the total combined catalyst volume of all of the second FT reactors of the second FT reactor stage, operating the second FT reactor stage at second FT operating conditions to convert at least a portion of the syngas in the second feed to second FT product hydrocarbons, separating the second FT hydrocarbon products into second liquid FT products and a second gas FT product stream, recycling a first portion of the second gas FT product stream as part of the first FT feed, recycling a second portion of the second gas FT product stream as part of the second FT feed, adjusting the temperature of a third portion of the second gas FT product stream, separating the third portion of the temperature-adjusted second gas FT product stream into third liquid FT products and a third gas FT product stream, recycling a first portion of the third gas FT product stream as part of the first FT feed, recycling a second portion of the third gas FT product stream as part of the second FT feed, and recycling a third portion of the third gas FT product stream as part of the carbonaceous source feed.

The present disclosure also includes one or more embodiments of an apparatus comprising an FT reactor having a first FT catalyst and a first heat transfer surface area to catalyst volume ratio configured to receive a first feed comprising synthesis gas and to convert a first portion of the synthesis gas in the first feed into first FT products comprising FT hydrocarbons and leave unconverted a second portion of the synthesis gas. The FT reactor is further configured to provide the unconverted second portion of the synthesis gas to a second FT reactor having a second FT catalyst and a second heat transfer surface area to catalyst volume ratio that is different from the first heat transfer surface area to catalyst volume ratio.

The present disclosure also includes one or more embodiments of an apparatus comprising a Fischer-Tropsch (“FT”) reactor having a first FT zone configured to provide a first heat transfer surface area to catalyst volume ratio and a second FT zone configured to provide a second heat transfer surface area to catalyst volume that is different from the heat transfer surface area to catalyst volume ratio of the first zone, wherein the first FT zone has a first FT catalyst and is configured to receive a first feed comprising synthesis gas and to operate under first FT conditions to convert a first portion of the synthesis gas in the first feed into first FT products and leave unconverted a second portion of the synthesis gas and further configured to provide the unconverted second portion of the synthesis gas as at least a portion of a second feed to the second FT zone, and the second FT zone has a second FT catalyst and is configured to receive the second feed and to operate under second FT conditions to convert unconverted synthesis gas in the second feed into second FT products.

These and other embodiments, features and advantages will be apparent in the following detailed description and drawings.

### BRIEF DESCRIPTION OF THE DRAWINGS

For a more detailed description of the present invention, reference will now be made to the accompanying drawing, wherein:

FIG. 1 is a schematic of a Fischer-Tropsch reactor cascade system suitable for conversion of hydrocarbonaceous feedstocks into Fischer-Tropsch hydrocarbons according to one or more embodiments of this disclosure, wherein a first FT reactor has a first FT catalyst and a first heat transfer surface area to catalyst volume ratio, and a second FT reactor has a second FT catalyst and a second heat transfer surface area to catalyst volume ratio that is different from the first heat transfer surface area to catalyst volume ratio.

FIG. 2 is a flowchart of a method of using a Fischer-Tropsch reactor cascade system to make Fischer-Tropsch hydrocarbons, in accordance with one or more embodiments of this disclosure.

FIG. 3 is a flowchart of a method of making synthesis gas and using the synthesis gas in a feed for a Fischer-Tropsch reactor cascade system to make Fischer-Tropsch hydrocarbons, in accordance with one or more embodiments of this disclosure.

### NOTATION AND NOMENCLATURE

As used herein, the term “tubular reactor” refers to Fischer-Tropsch reactors containing one or more tubes containing FT catalyst, wherein the inner diameter or average width of the one or more tubes is typically greater than about 0.5″.

As used herein, the phrase “a high-temperature Fischer-Tropsch (or ‘HTFT’) reactor” means an FT reactor that is typically operated at temperatures of 330° C.-350° C., which typically employs an iron-based catalyst. This process has been put to use extensively by Sasol in their Coal-to-Liquid (CTL) plants. As used herein, the phrase “a low-temperature Fischer-Tropsch (or ‘LTFT’) reactor” means an FT reactor that is operated at lower temperatures, generally in a range between 170° C.-235° C., which typically employs a cobalt-based catalyst.

As used herein, the term “microchannel reactor” refers to Fischer-Tropsch reactors containing one or more tubes or channels coated with and/or filled with Fischer-Tropsch catalyst, wherein the inner diameter or average width of the one or more tubes is less than about 0.25 inches, and more typically about 0.16 inches.

As used herein, the term “compact reactor” refers to Fischer-Tropsch reactors designed to operate at a higher specific cooling area. Such compact reactors generally have an inner diameter or average width of the one or more tubes that are larger than that of a microreactor but less than that of a conventionally sized FT reactor.

As used herein, the abbreviation “FT” and/or “F-T” stand for Fischer Tropsch (which may also be written “Fischer-Tropsch”).

As used herein, the term “FT tail gas” means gas produced from an FT reactor. The FT tail gas may typically contain unreacted hydrogen and carbon monoxide, as well as carbon dioxide, some light hydrocarbons, and other light reaction byproducts.

As used herein, the term “FT water” or “FT water stream” means water produced by an FT reaction. The FT water will typically include dissolved oxygenated species, such as alcohols, and light hydrocarbons.

As used herein, the term “liquid FT hydrocarbon products” means liquid hydrocarbons produced by an FT reactor.

As used herein, the term “poison” refers to a component that reversibly interacts with a particular catalyst (i.e., a catalyst inhibitor that slows the reaction rate) and/or irreversibly deactivates the catalyst. Examples include Group 1 alkali metals, such as potassium, and sulfur compounds with respect to cobalt-based catalysts and halides with respect to both cobalt-based and iron-based catalysts. As noted above, a substance may be a poison with respect to one type of catalyst while acting as a promoter for iron catalysts.

Use of the term “tubular” is not meant to be limiting to a specific cross sectional shape. For example, tubes may have a cross-sectional shape that is not circular. Accordingly, the tubes of a tubular reactor may, in one or more embodiments, have a circular, oval, rectangular, and/or other cross sectional shape(s).

As used herein, the terms “reformed gas,” “synthesis gas” and “syngas” are used to refer to streams comprising, but not limited to, hydrogen and carbon monoxide. When used to describe synthesis gas, the term “fresh” is used herein to indicate that the synthesis gas (i.e., the fresh synthesis gas) has not previously passed through an FT reactor and been extracted unreacted therefrom.

“Activity” is defined herein as a parameter that reflects the speed of conversion of carbon monoxide (CO) per unit catalyst and per unit time. This parameter may be expressed in such a way that is independent of temperature, pressure, and reactant concentration. It is usually expressed as the “A” in the equation:

$${rate}_{CO} = {Ae}^{\frac{- {E}_{A}}{RT}} f ( {P}_{i} ) \qquad ( 3 )$$

wherein the rate_{CO} is the rate of CO converted per unit volume of catalyst per unit time. E_{A} is the Fischer Tropsch activation energy, R the gas Universal constant, and T the absolute temperature. The function of f(Pᵢ) describes the impact of the reactant and product concentration on the rate of CO conversion and is expressed as a function of partial pressure (Pᵢ). It may be difficult to compare two different catalysts because each may behave very differently under similar process conditions, depending on their composition and physical properties. Each catalyst composition will have its unique f(Pᵢ) partial pressure function. The value of f(Pᵢ) is usually obtained after much research working with several gas compositions and several temperature and pressure conditions.

“Productivity” is defined herein as the rate of carbon monoxide (CO) converted per unit time and per unit of catalyst at a predetermined temperature. Productivity may be expressed as standard volume of CO in cc converted per volume of catalyst in cc per hour.

“Selectivity” is defined herein as the fraction of a certain chemical compound produced from the overall carbon monoxide (CO) conversion.

The “catalyst volume” of a fixed bed in a reactor tube of a tubular FT reactor is defined as the total inner volume of that part of the reactor tube where the fixed bed of catalyst particles is present. The catalyst volume thus includes the total inner volume of that part of the reactor tube, both the volume occupied by the catalyst particles, as well as the volume comprised of the voids between the catalyst particles. The “total catalyst volume of a fixed bed, tubular reactor” means the sum of all of the catalyst volumes of all the tubes of that reactor.

As used herein and as mentioned above, the abbreviation “HTFT” with respect to an FT reactor stands for “high-temperature Fischer-Tropsch,” while the abbreviation “LTFT” with respect to an FT reactor stands for “low-temperature Fischer-Tropsch.”

As used herein, with respect to an FT plant, (1) the abbreviation “GTL” stands for gas-to-liquids; the abbreviation “CTL” stands for coal-to-liquids;

As used herein and as mentioned above, the abbreviation “WGSR” stands for water-gas-shift reaction.

As used herein, the abbreviation “S/V” stands for heat transfer surface area to catalyst volume ratio.

As used herein, the abbreviation “GHSV” stands for gas hourly space velocity.

As used herein, “carbonaceous” or “hydrocarbonaceous” feedstocks means hydrocarbon feedstocks used to make syngas and may include but are not limited to biomass, natural gas, associated gas, coal-bed methane, residual oil fraction(s), coal, brown coal, peat, municipal waste and combinations thereof.

### DETAILED DESCRIPTION

Overview.

Herein disclosed are embodiments comprising systems, methods, and apparatuses for the production of Fischer-Tropsch products. One or more embodiments of this disclosure incorporates a cascade comprising at least two stages of Fischer-Tropsch reactors, wherein a first stage comprises at least one Fischer-Tropsch reactor having a first FT catalyst and a first heat transfer surface area to catalyst volume ratio, and a second stage comprises at least one Fischer-Tropsch reactor having a second FT catalyst and a second heat transfer surface area to catalyst volume ratio that Is different from the first heat transfer surface area to catalyst volume ratio. The first heat transfer surface area to catalyst volume ratio may be less than the second heat transfer surface area to catalyst volume ratio, which may be useful, for example, to protect the second FT catalyst from poisoning. Alternatively, the first heat transfer surface area to catalyst volume ratio may be greater than the second heat transfer surface area to catalyst volume ratio, which may be useful, for example, if the syngas feedstock being used for the first FT reactor is highly reactive, i.e, has a high combined partial pressure of hydrogen and carbon monoxide.

In one or more embodiments, there may be additional differences between the first and second FT reactors. For example, in one or more embodiments, the at least one Fischer-Tropsch reactor of the first stage is a different type of Fischer-Tropsch reactor than the at least one Fischer-Tropsch reactor of the second stage, e.g., the at least one Fischer-Tropsch reactor of the first stage may be a tubular reactor and the at least one Fischer-Tropsch reactor of the second stage may be a microchannel, compact reactor or slurry bed reactor. In one or more embodiments, the at least one Fischer-Tropsch reactor is a microchannel, compact reactor or slurry bed reactor and the at least one Fischer-Tropsch reactor of the second stage may be a tubular reactor. In one or more embodiments, the at least one Fischer-Tropsch reactor of the second stage has a substantially higher productivity than the at least one Fischer-Tropsch reactor of the first stage. In one or more embodiments, the at least one Fischer-Tropsch reactor of the second stage has a substantially lower productivity than the at least one Fischer-Tropsch reactor of the first stage. In one or more embodiments, the pressure drop over the at least one Fischer-Tropsch reactor of the second stage is greater than the pressure drop across the at least one Fischer-Tropsch reactor of the first stage. In one or more embodiments, the pressure drop over the at least one Fischer-Tropsch reactor of the second stage is less than the pressure drop across the at least one Fischer-Tropsch reactor of the first stage. These and other embodiments, and components of the systems and methods for producing FT products via the disclosed systems will be described in detail herein below.

Fischer-Tropsch System Comprising Reactor Cascade.

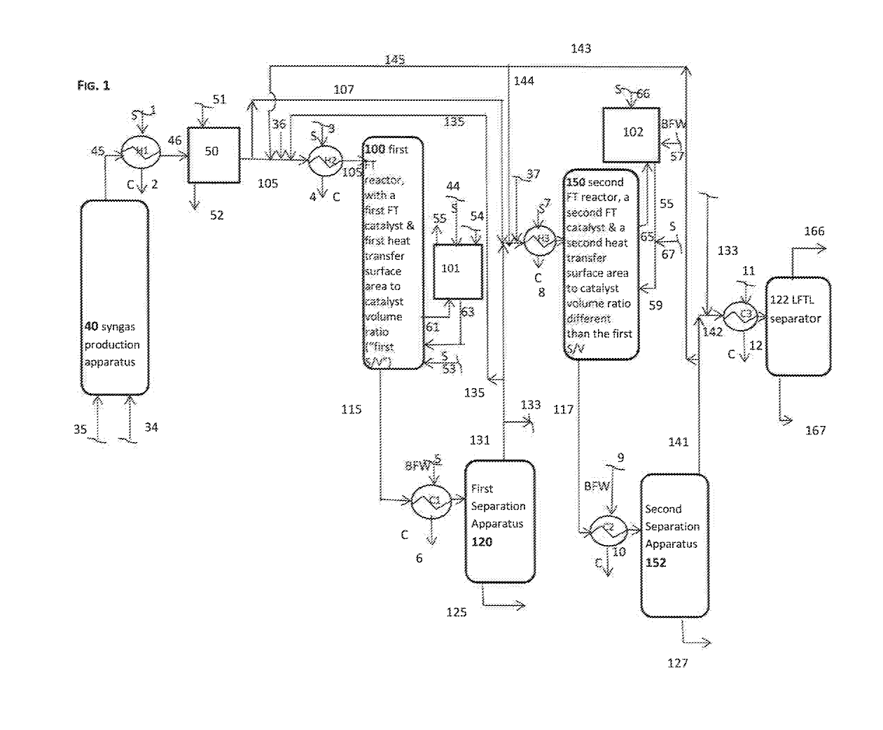

Herein disclosed are embodiments for a Fischer-Tropsch system comprising a cascade of at least two stages of FT reactors, each stage comprising at least one FT reactor. Description of the disclosed Fischer-Tropsch system will now be made with reference to FIG. 1, which is a schematic of a Fischer-Tropsch reactor cascade system according to one or more embodiments of this disclosure. The Fischer-Tropsch reactor cascade system of FIG. 1 comprises a first FT reactor 100 in series with a second FT reactor 150. The first FT reactor 100 has a first FT catalyst and a first heat transfer surface area to catalyst volume ratio. The second FT reactor 150 has a second FT catalyst and a second heat transfer surface area to catalyst volume ratio that is different from the first heat transfer surface area to catalyst volume ratio. The first FT reactor 100 is fluidly connected with the second FT reactor 150, whereby unreacted synthesis gas exiting the first FT reactor 100 can be introduced into the second FT reactor 150.

In addition to having different S/V ratios, the first FT reactor 100 may also differ from the second FT reactor 150 in other ways. For example, in one or more embodiments, the first FT reactor 100 is generally more resistant to poisoning by contaminants commonly found in a synthesis gas feed than is the second FT reactor 150. For example, the first FT reactor 100 may be more resistant to poisoning by sulfur compounds, including, but not limited to, hydrogen sulfide. For example, such poison resistance may be provided by have the first heat transfer surface area to catalyst volume ratio being smaller than the second heat transfer surface area to catalyst volume ratio or may be supplementally provided by using a poison-resistant catalyst in the first FT reactor (as the first FT catalyst). In this way, the first FT reactor 100 may dually serve as an FT production reactor and as a guard bed, protecting the second FT reactor 150 from poisoning. As opposed to conventional guard beds, however, the first FT reactor 100 produces FT products, i.e., the purpose of the first FT reactor 100 is not only to remove contaminants from a synthesis gas feed, but also to produce FT products. Due to the contaminant reduction provided by first FT reactor 100, the second FT reactor 150 may be operable with and/or may contain a more expensive catalyst than first FT reactor 100. The first FT reactor and the second FT reactor 150 may differ in other ways, for example, by productivity (which may include but is not limited to use of catalysts having a different level of productivity) and/or by operating temperature and/or by pressure drops, and/or by CO conversion levels and/or by water vapor partial pressures, as discussed further herein.

Still other examples of ways in which the first FT reactor 100 and the second FT reactor 150 may differ include by having a different pressure drop per unit reactor length and/or by use of a lower cost catalyst used in the first FT reactor 100 compared to the second FT reactor 150. In one or more embodiments, the first FT reactor 100 and the second FT reactor 150 may differ by dimension or their dimensions may be the same. In one or more embodiments, the first FT reactor 100 and the second FT reactor 150 may use different catalysts or their catalysts may be the same.

The First FT Reactor 100.

In embodiments, the first FT reactor 100 is an FT reactor of any type, having a first FT catalyst and a first heat transfer surface area to catalyst volume ratio that is different from a second heat transfer surface area to catalyst volume ratio of a second FT reactor in series with the first FT reactor. In one or more embodiments, the first FT reactor 100 comprises a fixed bed reactor. In one or more embodiments, the first FT reactor 100 comprises a tubular reactor. In one or more embodiments, the first FT reactor 100 comprises a fluidized bed reactor. In one or more embodiments, the first FT reactor 100 comprises a slurry bed reactor, such as, but not limited to, a slurry bubble column reactor. In one or more embodiments, the first FT reactor 100 comprises a microreactor or a compact reactor. In one or more embodiments, the first FT reactor 100 comprises an FT reactor of any type.

The disclosed Fischer-Tropsch reactor cascade system of FIG. 1 and method used therewith may employ one or more of a variety of FT catalytic metals, such as Group 8-10 metals, including, but not limited to, iron, nickel, ruthenium, and/or cobalt. As discussed further herein below, in one or more embodiments of the present disclosure, cobalt-based catalysts are employed. As known in the art, a cobalt-based FT catalyst may comprise cobalt impregnated into or onto any convenient catalyst carrier or support material, including, but not limited to, alumina (Al₂O₃), titania (TiO₂), and silica (SiO₂). Exotic carriers and promoters, such as platinum (Pt), palladium (Pd), rhenium (Re), and ruthenium (Ru) may also be employed. Other suitable catalyst carrier(s) and promoter(s) are known in the art and may be incorporated. The catalyst carrier may be in any convenient shape (e.g., spheres, pellets, trilobes, etc.).

In one or more embodiments, the first FT reactor 100 contains and/or is configured for operation with a FT catalyst selected from cobalt-based FT catalysts, iron-based FT catalysts, or ruthenium-based FT catalysts. In one or more embodiments, the first FT reactor 100 contains and/or is configured for operation with a bimetallic FT catalyst. In one or more embodiments, the first FT reactor 100 contains and/or is configured for operation with a bimetallic FT catalyst selected from cobalt-ruthenium FT catalysts, iron-nickel catalysts, and combinations thereof. In one or more embodiments, the first FT reactor 100 contains and/or is configured for operation with a catalyst selected from cobalt-based catalysts and ruthenium-based catalysts. In one or more embodiments, the first FT reactor 100 does not contain and/or is not configured for operation with an Iron-based FT catalyst. In one or more embodiments, the first FT reactor 100 does not contain and/or is not configured for operation with an FT catalyst having iron as the predominant active metal. In one or more embodiments, the first FT reactor 100 contains and/or is operable with a catalyst that is less active (i.e., that produces less FT product per quantity of catalyst over time) than that of a second catalyst used with the second FT reactor 150. In one or more embodiments, the first FT reactor 100 contains and/or is operable with a low cost catalyst, i.e., a catalyst considered a sacrificial catalyst. Such an embodiment, however, is different from use of a guard bed, because the first catalyst used with the first FT reactor 100 would perform FT synthesis and the products produced by the first FT reactor 100 may be blended with products produced by the second FT reactor 150.

In one or more embodiments, the first FT reactor 100 contains and/or is operable with a catalyst exhibiting an activity towards production of heavy FT products. In such embodiments, the first FT reactor 100 has a higher selectivity of heavy products (carbon number 20 or higher) than the second FT reactor 150. This is a different consideration than methane selectivity. Preferentially, in such embodiments, the second FT reactor 150 has a selectivity of light products (C₁-C₂₀) of less than 70%. In one or more embodiments, the first FT reactor 100 contains and/or is operable with a low productivity cobalt-based FT catalyst. Suitable low productivity catalysts include, but are not limited to, Co/Si, Co/Ti, and Co/AI catalysts, with or without promoters. In one or more embodiments, the first FT reactor 100 is configured for operation at a productivity that is less than the productivity of the second FT reactor 150. In one or more embodiments, the first FT reactor 100 is configured for operation with a catalyst productivity of less than about 300, 250, or 200 standard cubic centimeters of carbon monoxide per cubic centimeter of catalyst per hour (cc CO/cc cat/h).

As previously mentioned herein, in one or more embodiments, the first FT reactor 100 comprises a tubular reactor or is tubular in nature. Accordingly, in one or more embodiments, the first FT reactor 100 comprises one or more reactor tubes having an FT catalyst disposed therein and/or thereon, as would be known to one of skill in the art. In one or more embodiments, the first FT reactor 100 comprises a tubular fixed bed FT reactor. The number of tubes in a multi-tubular reactor is not critical to the disclosure and may vary widely. In one or more embodiments, the first FT reactor 100 is a tubular reactor containing from about 0.15 to about 4 liters, from about 0.2 to about 3.5 liters, or from about 0.4 to about 3 liters catalyst coated and/or catalyst containing tubes. In one or more embodiments, the first FT reactor 100 comprises a tubular reactor containing tubes having an average tube length in the range from about 15 to about 40 feet, from about 15 to about 35, or from about 25 to about 30. In one or more embodiments, the first FT reactor 100 comprises a tubular reactor containing tubes having an average inner tube diameter (or average inner cross-section width) that is in the range from about 0.5 inch to about 2 inches, from about 0.6 to about 1.5 inches, or from about 0.7 to about 0.9 inch. In one or more embodiments, the first FT reactor 100 comprises a tubular reactor containing tubes having an average inner tube diameter (or average inner cross-section width) that is greater than or equal to about 0.5, 0.75, 1, or 2 inches. In one or more embodiments, the first FT reactor 100 comprises a tubular reactor containing at least one tube having an average inner tube diameter (or inner cross section width) that is greater than or equal to about 0.5, 0.75, 1, or 2 inches.

In one or more embodiments, the first FT reactor 100 has a heat transfer surface area to catalyst volume ratio that is less than the heat transfer surface area to catalyst volume ratio of the second FT reactor 150. In one or more embodiments, the configuration for the first FT reactor 100 having a lesser heat transfer surface area to catalyst volume ratio than the second FT reactor 150 enables the first FT reactor 100 to be operated with a lower CO conversion level, producing less liquid products than the second FT reactor 150, and to have a lower pressure drop than the pressure drop across the second FT reactor 150. In one or more embodiments, the first heat transfer surface area to catalyst volume ratio of the first FT reactor 100 is less than about 8 inch⁻¹. In one or more embodiments, the first heat transfer surface area to catalyst volume ratio of the first FT reactor 100 is less than about 7.5 inch⁻¹. In one or more embodiments, the heat transfer surface area to catalyst volume ratio of the first FT reactor 100 is less than about 7 inch⁻¹.

In one or more embodiments, the first FT reactor 100 has a heat transfer surface area to catalyst volume ratio that is greater than the heat transfer surface area to catalyst volume ratio of the second FT reactor 150. Such embodiments may be useful, for example in situations where the first feed syngas for the first FT reactor has a high total partial pressure of hydrogen and carbon monoxide. For example, syngas produced from an autothermal reactor may typically have a higher total partial pressure of hydrogen and carbon monoxide than would syngas from a steam methane reformer. Use of such a syngas, having a higher total partial pressure of hydrogen and carbon monoxide, in an FT reactor results in generation of a large amount of heat, which is advantageously handled by an FT reactor having a high heat transfer surface area to catalyst volume ratio. The hydrogen and carbon monoxide in the unreacted synthesis gas exiting the first FT reactor 100 would have a lesser partial pressure than the hydrogen and carbon monoxide in the first feed syngas to the first FT reactor 100. The unreacted synthesis gas exiting the first FT reactor 100 would be introduced into the second FT reactor 150. The lower total partial pressure of hydrogen and carbon monoxide in the unreacted synthesis gas would be adequately handled by the lower heat transfer surface area to catalyst volume ratio of the second FT reactor 150. In one or more embodiments, the first FT reactor 100 is selected from non-tubular reactors and the second FT reactor 150 is a tubular reactor. In one or more embodiments, the first FT reactor 100 is selected from the group of microchannel reactors and compact reactors, while the second FT reactor 150 is a tubular fixed bed FT reactor. In one or more embodiments, the first FT reactor 100 comprises a slurry reactor, while the second FT reactor 150 is a tubular fixed bed FT reactor. Multi-tubular reactors suitable for the first FT reactor 100 in such applications include but are not limited to microchannel reactors described in U.S. Pat. No. 7,829,602, which is hereby incorporated herein by reference in its entirety for all purposes not contrary to this disclosure. In one or more embodiments, the first FT reactor 100 comprises a compact spiral plate and spiral tube reactor substantially similar to or the same as that described in U.S. Patent Application No. 61/799,485 or a compact spiral finned reactor substantially similar to or the same as that described in U.S. Patent Application No. 61/799,825, both of which were filed internationally as PCT/US14/29746 and each of which is incorporated herein by reference in its entirety for all purposes not contrary to this disclosure. In one or more embodiments, the first FT reactor 100 comprises a compact finned panel reactor substantially similar to or the same as that described in U.S. Patent Application No. 61/800,090, filed internationally as PCT/US14/29886, which is incorporated herein by reference in its entirety for all purposes not contrary to this disclosure.

In one or more embodiments wherein the first heat transfer surface area to catalyst volume ratio of the first FT reactor 100 is greater than the second heat transfer surface area to catalyst volume area of the second FT reactor 150, the first heat transfer surface area to catalyst volume ratio of the first FT reactor 100 is greater than about 8 inch⁻¹. In one or more embodiments wherein the first heat transfer surface area to catalyst volume ratio is greater than the second heat transfer surface area to catalyst volume area, the first heat transfer surface area to catalyst volume ratio of the first FT reactor 100 is greater than about 8.5 inch⁻¹. In one or more embodiments wherein the first heat transfer surface area to catalyst volume ratio is greater than the second heat transfer surface area to catalyst volume area, the first heat transfer surface area to catalyst volume ratio of the first FT reactor 100 is greater than about 9 inch⁻¹. In one or more embodiments wherein the first heat transfer surface area to catalyst volume ratio is greater than the second heat transfer surface area to catalyst volume area, the first heat transfer surface area to catalyst volume ratio of the first FT reactor 100 is greater than about 8 inch⁻¹, and the second heat transfer surface area to catalyst volume area of the second FT reactor 150 is less than about 8 inch⁻¹. In one or more embodiments wherein the first heat transfer surface area to catalyst volume ratio is greater than the second heat transfer surface area to catalyst volume area, the first heat transfer surface area to catalyst volume ratio of the first FT reactor 100 is greater than about 8, 8.5, or 9 inch⁻, and the second heat transfer surface area to catalyst volume area of the second FT reactor 150 is less than about 8, 7.5, or 7 inch⁻¹. In one or more embodiments wherein the first heat transfer surface area to catalyst volume ratio is greater than the second heat transfer surface area to catalyst volume area, the second heat transfer surface area to catalyst volume ratio of the second FT reactor 150 is less than about 8 inch⁻¹. In one or more embodiments wherein the first heat transfer surface area to catalyst volume ratio is greater than the second heat transfer surface area to catalyst volume area, the second heat transfer surface area to catalyst volume ratio of the second FT reactor 150 is less than about 7.5 inch⁻¹. In one or more embodiments wherein the first heat transfer surface area to catalyst volume ratio is greater than the second heat transfer surface area to catalyst volume area, the second heat transfer surface area to catalyst volume ratio of the second FT reactor 150 is less than about 7 inch⁻¹.

In one or more embodiments, the first FT reactor 100 is operable at a lower gas hourly space velocity (GHSV) than the second FT reactor 150. In one or more embodiments, the first FT reactor 100 is configured for operation at a GHSV that is less than or equal to about 1000 h⁻¹, less than or equal to about 1200 h⁻¹, or less than or equal to about 1500 h⁻¹.

In one or more embodiments, the first FT reactor 100 is configured for operation at a lower temperature than that for which the second FT reactor 150 is configured. In one or more embodiments, the first FT reactor 100 is configured for operation at a temperature in the range of from about 160° C. to about 240° C., from about 180° C. to about 235° C., or from about 190° C. to about 220° C. In one or more embodiments, the first FT reactor 100 is configured for operation at a pressure in the range of from about 200 psig to about 650 psig, from about 300 psig to about 480 psig, or from about 350 psig to about 450 psig.

In one or more embodiments, the first FT reactor 100 is configured for operation with a pressure drop thereacross that is less than the pressure drop for which the second FT reactor 150 is configured. In one or more embodiments, the first FT reactor 100 is configured for operation with a pressure drop of less than about 3 psi, less than about 2 psi, or less than about 1 psi per foot of reactor length. In one or more embodiments, the first FT reactor 100 is operable at a water vapor partial pressure that is less than that of the second FT reactor 150. In one or more embodiments, the first FT reactor 100 is operable at a water vapor partial pressure at the reactor exit of up to about 5, 4, or 3 bar.

The first FT reactor 100 produces a first FT water stream and first FT products comprising first liquid FT hydrocarbon products and a first FT tail gas stream. The first FT tail gas stream may include both gaseous FT hydrocarbon products, unreacted synthesis gas and in some cases other components. In one or more embodiments, the first FT water stream exits the first FT reactor 100 separately from the first liquid FT hydrocarbon products and the first FT tail gas stream. The feed to the second FT reactor comprises the at least a portion of the first FT tail gas stream.

The Second FT Reactor 150.

In embodiments, the second FT reactor 150 is an FT reactor of any type having a second FT catalyst and a second heat transfer surface area to catalyst volume ratio that is different from the first heat transfer surface area to catalyst volume ratio of the first FT reactor. In one or more embodiments, the second FT reactor 150 is a fixed bed reactor. In one or more embodiments, the second FT reactor 150 is a tubular reactor. In one or more embodiments, the second FT reactor 150 is a microchannel reactor or a compact reactor. In one or more embodiments, the second FT reactor 150 is a fluidized bed reactor. In one or more embodiments, the second FT reactor 150 is a slurry bed reactor, such as, but not limited to, a slurry bubble column reactor. In one or more embodiments, the second FT reactor 150 contains and/or is configured for operation with an FT catalyst selected from cobalt-based FT catalysts, iron-based FT catalysts, and ruthenium-based FT catalysts. In one or more embodiments, the second FT reactor 150 contains and/or is configured for operation with a bimetallic FT catalyst. In one or more embodiments, the second FT reactor 150 contains and/or is configured for operation with a bimetallic FT catalyst selected from cobalt-ruthenium FT catalysts, iron-nickel FT catalysts, cobalt-platinum FT catalysts, cobalt-palladium FT catalysts, and combinations thereof. In one or more embodiments, the second FT reactor 150 contains and/or is configured for operation with a catalyst selected from cobalt-based catalysts and ruthenium-based catalysts. In one or more embodiments, the second FT reactor 150 does not contain and/or is not configured for operation with an iron-based FT catalyst. In one or more embodiments, the second FT reactor 150 does not contain and/or is not configured for operation with an FT catalyst having iron as the predominant active metal. In one or more embodiments, the second FT reactor 150 contains and/or is operable with a higher productivity cobalt-based FT catalyst than is used with the first FT reactor 100. Suitable high productivity catalysts include, but are not limited to, Co/Ru, Co/Pd, and Co/Pt catalysts. As mentioned hereinabove, in one or more embodiments, the second FT reactor 150 is configured for operation at a catalyst productivity that is greater than the productivity of the first FT reactor 100. For example, the second FT reactor 150 may be configured for operation with a catalyst productivity of greater than about 300, 350, or 400 standard cubic centimeters of carbon monoxide per cubic centimeter of catalyst per hour (cc CO/cc cat/h). In one or more embodiments, the first FT reactor 100 is configured for operation with a catalyst productivity of less than about 300 cc CO/cc cat/h, while the second FT reactor 150 is configured for operation with a carbon monoxide conversion of greater than about 300 cc CO/cc cat/h. In one or more embodiments, the first FT reactor 100 is configured for operation with a catalyst productivity of less than about 300, 250, or 200 cc CO/cc cat/h, and the second FT reactor 150 is configured for operation with a catalyst productivity of greater than about 300, 400, or 600 cc CO/cc cat/h.

In one or more embodiments, the first FT reactor 100 is a tubular reactor and the second FT reactor 150 is selected from all other (non-tubular) types of FT reactors. In one or more embodiments, the second FT reactor 150 is selected from the group of microchannel reactors and compact reactors. In one or more embodiments, the second FT reactor 150 comprises a compact reactor. In one or more embodiments, the second FT reactor 150 comprises a tubular reactor or is tubular in nature. In one or more embodiments, the second FT reactor 150 comprises one or more reactor tubes and/or channels having FT catalyst disposed therein and/or thereon, as known to those of skill in the art. In one or more embodiments, the second FT reactor 150 is a tubular fixed bed FT reactor. Thus, in one or more embodiments, either or both of the first FT reactor 100 and/or the second FT reactor 150 are fixed bed tubular reactors. A reactor tube in either the first FT reactor 100 and/or the second FT reactor 150 may be filled partly or entirely with a catalyst bed comprising FT catalyst particles or filled with inert material of heat conductive material. As mentioned in the “Notation and Nomenclature” section above, the ‘catalyst volume’ of a fixed bed in a reactor tube is defined as the inner volume of that part of the reactor tube where the fixed bed of catalyst particles is present. This volume thus includes the both volume occupied by the catalyst particles, as well as the volume of the voids between the catalyst particles. In one or more embodiments, the first FT reactor 100 and/or the second FT reactor 150 comprise one or more reactor tubes with a fixed bed of catalyst particles over a predetermined length of the corresponding reactor tube.

As discussed in detail herein below, the second FT reactor 150 may comprise a multi-tubular reactor. To accommodate and provide for a second heat transfer surface area to catalyst volume ratio (also referred to herein as ‘S/V’), that is greater than the first heat transfer surface area to catalyst volume ratio of the first FT reactor 100, the second FT reactor 150 may, in one or more embodiments, be configured with a greater heat transfer surface area than that of the first FT reactor 100. This may result from, for example, the use of smaller but more numerous tubes within the second FT reactor 150 relative to the size and number of tubes in the first FT reactor 100. In one or more embodiments, the tubes in the second FT reactor 150 may be smaller in diameter than the tubes of the first FT reactor 100. As a result of the presence of a greater number of tubes in the second FT reactor 150 than in the first FT reactor 100, the spacing and dimensions of the tubes of the second FT reactor 150 may be smaller or compacted than tubes of the first FT reactor 100, such that the second catalyst is more compact than the first catalyst. The S/V ratio is inversely proportional to tube internal diameter, such that as the tube internal diameter decreases, the S/V ratio increases. This reduction in the tube's internal dimension may force to the use of smaller catalyst particle sizes and therefore may result in the greater pressure drop across the second FT reactor 150 relative to the pressure drop across the first FT reactor 100, as described further herein below.

Multi-tubular reactors and the use of same in Fischer-Tropsch systems and processes are known in the art. Multi-tubular reactors suitable for the second FT reactor 150 include but are not limited to microchannel reactors described in U.S. Pat. No. 7,829,602, which is hereby incorporated herein by reference in its entirety for all purposes not contrary to this disclosure. In one or more embodiments, the second FT reactor 150 comprises a microchannel reactor substantially similar to or the same as that described in U.S. Pat. No. 7,829,602, which is incorporated herein by reference in its entirety for all purposes not contrary to this disclosure. In one or more embodiments, the second FT reactor 150 comprises a compact spiral plate and spiral tube reactor substantially similar to or the same as that described in U.S. Patent Application No. 61/799,485 or a compact spiral finned reactor substantially similar to or the same as that described in U.S. Patent Application No. 61/799,825, both of which were filed internationally as PCT/US14/29746 and each of which is incorporated herein by reference in its entirety for all purposes not contrary to this disclosure. In one or more embodiments, the second FT reactor 150 comprises a compact finned panel reactor substantially similar to or the same as that described in U.S. Patent Application No. 61/800,090, filed internationally as PCT/US14/29886, which is incorporated herein by reference in its entirety for all purposes not contrary to this disclosure.

The number of channels in a microchannel reactor is not believed to be critical to the disclosure and may vary widely. In one or more embodiments, the second FT reactor 150 comprises a microchannel reactor containing channels having an average opening in the range from about 0.1 mm to about 8 mm, from about 0.2 mm to about 5 mm, or from about 0.5 mm to about 3 mm. In one or more embodiments, the second FT reactor 150 comprises a tubular or microchannel reactor containing at least one tube or microchannel having an average inner tube or microchannel opening that is less than about 0.5 Inches. In one or more embodiments, the first FT reactor 100 comprises a tubular reactor containing at least one tube having an average inner tube or diameter (or average cross sectional dimension) that is greater than about 0.5, 1, or 2 inches, while the second FT reactor 150 comprises a tubular or microchannel reactor containing at least one tube or microchannel having an average inner tube or microchannel opening (or average cross sectional dimension) that is less than about 3, 1, 0.2 mm.

As mentioned above, in one or more embodiments, the second FT reactor 150 has a second heat transfer surface area to catalyst volume ratio that is greater than the first heat transfer surface area to catalyst volume ratio of the first FT reactor 100. In one or more embodiments, the second heat transfer surface area to catalyst volume ratio of the second FT reactor 150 is greater than about 8 inch⁻¹. In one or more embodiments, the second heat transfer surface area to catalyst volume ratio of the second FT reactor 150 is greater than about 8.5 inch⁻¹. In one or more embodiments, the second heat transfer surface area to catalyst volume ratio of the second FT reactor 150 is greater than about 9 inch⁻¹. In one or more embodiments, the first heat transfer surface area to catalyst volume ratio of the first FT reactor 100 is less than about 8 inch⁻¹, and the second heat transfer surface area to catalyst volume area of the second FT reactor 150 is greater than about 8 inch⁻¹. In one or more embodiments, the first heat transfer surface area to catalyst volume ratio is less than about 8, 7.5, or 7 inch⁻¹, and the second heat transfer surface area to catalyst volume area is greater than about 8, 8.5, or 9 inch⁻¹.

In alternative embodiments, the second heat transfer surface area to catalyst volume of the second FT reactor 150 may be less than the first heat transfer surface area to catalyst volume ratio of the first FT reactor 100. This may result from, for example, the use of larger but less numerous tubes within the second FT reactor 150 relative to the size and number of tubes in the first FT reactor 100. In one or more embodiments, the tubes in the second FT reactor 150 may be larger in diameter than the tubes of the first FT reactor 100. As a result of the presence of a lesser number of tubes in the second FT reactor 150 than in the first FT reactor 100, the spacing and dimensions of the tubes of the second FT reactor 150 may be lesser or less compacted than tubes of the first FT reactor 100, such that the first catalyst is more compact than the second catalyst. The S/V ratio is inversely proportional to tube internal diameter, such that as the tube internal diameter decreases, the S/V ratio increases. A reduction in the tube's internal dimension may force to the use of smaller catalyst particle sizes and therefore may result in the greater pressure drop across the first FT reactor 100 relative to the pressure drop across the second FT reactor 150.

In one or more embodiments, the second FT reactor 150 is operable at a higher gas hourly space velocity (GHSV) than the first FT reactor 100. In one or more embodiments, the second FT reactor 150 is configured for operation at a GHSV that is greater than or equal to about 1500 h⁻¹, greater than or equal to about 2000 h⁻¹, or greater than or equal to about 3000 h⁻¹.

In one or more embodiments, the second FT reactor 150 is configured for operation at a higher temperature than that for which the first FT reactor 100 is configured. In one or more embodiments, the second FT reactor 150 is configured for operation at a temperature in the range of from about 200° C. to about 250° C., from about 190° C. to about 240° C., or from about 200° C. to about 230° C., while the first FT reactor 100 is configured for operation at a temperature in the range of from about 160° C. to about 240° C., from about 180° C. to about 235° C., or from about 190° C. to about 220° C. In one or more embodiments, the second FT reactor 150 is configured for operation at a pressure in the range of from about 200 psig to about 550 psig, from about 350 psig to about 500 psig, or from about 400 psig to about 450 psig.

In one or more embodiments, the second FT reactor 150 is configured for operation at a lower temperature than that for which the first FT reactor 100 is configured. In one or more embodiments wherein the second FT reactor 150 is configured for operation at a lower temperature than that for which the first FT reactor 100 is configured, the second FT catalyst is more active than the first FT catalyst.

In embodiments wherein a higher heat transfer surface area to catalyst volume is utilized in the second FT reactor 150 than the first FT reactor 100, in one or more embodiments, the second FT reactor 150 may be configured for operation with a smaller catalyst particle size resulting in a pressure drop thereacross that is greater than the pressure drop for which the first FT reactor 100 is configured. In one or more embodiments, the first FT reactor 100 is configured for operation with a pressure drop of less than about 3 psi, 2 psi, or 1 psi per foot of tube length and the second FT reactor 150 is configured for operation with a pressure drop of greater than about 4 psi, 8 psi, or 10 psi per foot of tube length.

Alternatively, in embodiments wherein a higher heat transfer surface area to catalyst volume is utilized in the first FT reactor 100 than in the second FT reactor 150, in one or more embodiments, the second FT reactor 150 may be configured for operation with a larger catalyst particle size resulting in a pressure drop thereacross that is less than the pressure drop for which the first FT reactor 100 is configured. In one or more embodiments, the second FT reactor 150 is configured for operation with a pressure drop of less than about 3 psi, 2 psi, or 1 psi per foot of tube length and the first FT reactor 100 is configured for operation with a pressure drop of greater than about 4 psi, 8 psi, or 10 psi per foot of tube length.

As mentioned herein above, in one or more embodiments, the second FT reactor 150 is operable at a water vapor partial pressure that is greater than that of the first FT reactor 100. In one or more embodiments, the second FT reactor 150 is operable at a water vapor partial pressure of up to at least about 6 bar. In one or more embodiments, the first FT reactor 100 is operable at water vapor partial pressures of less than about 5 bar, and the second FT reactor 150 is operable to water vapor partial pressures greater than 5 bar. In one or more embodiments, the first FT reactor 100 is operable at water vapor partial pressures of less than about 5 bar, and the second FT reactor 150 is operable to water vapor partial pressures of up to at least about 6 bar.

The second FT reactor 150 produces a second FT water stream and second FT products comprising second liquid FT hydrocarbon products and a second FT tall gas stream. The second FT tail gas stream comprises gaseous FT hydrocarbon products and unreacted synthesis gas and in some cases other components. In one or more embodiments, the second FT water stream exits the second FT reactor 150 separately from the second liquid FT hydrocarbon products and the second FT tail gas stream.

Separation Apparatus.

As depicted in FIG. 1, in one or more embodiments, the Fischer-Tropsch reactor cascade system of the present disclosure may further comprise one or more separation apparatus. For example, as depicted in FIG. 1, the Fischer-Tropsch reactor cascade system may further comprise a first separation apparatus 120 fluidly connected with the first FT reactor 100 via a first FT product outlet line 115. Preferably, the first liquid FT hydrocarbon products and first FT tail gas stream exit the first FT reactor 100 via the first FT product outlet line 115. Similarly, the output of the second FT reactor 150 may be fluidly connected with a second separation apparatus 152 via a second FT product outlet line 117. Preferably, the second liquid FT hydrocarbon products and the second FT tail gas stream exit the second FT reactor 100 via the second FT product outlet line 117.

In one or more embodiments, the first separation apparatus 120 may comprise a gas/liquid separator. In one or more embodiments, in the first separation apparatus 120, liquid FT hydrocarbon products are separated from the first FT tail gas. The separated first liquid FT hydrocarbon products exit from the first separation apparatus 120 via a first separation apparatus liquid outlet line 125. The separated first FT tail gas stream exits the first separation apparatus 120 via a first separation apparatus gas outlet line 131.

The first separation apparatus 120 may comprise one or more gas/liquid separators, each of which may comprise any separator known in the art to be operable to separate liquid hydrocarbons from gaseous components within the FT product introduced thereto via line 115. For example, in one or more embodiments, the gas/liquid separator is selected from the group consisting of knock out drums, scrubbers or similar devices. The gas/liquid separator may remove hydrocarbon that can be condensed via cooling (as indicated by a cooler C1) and may reduce water content in the vapor stream. As the hydrocarbon is condensed, liquid drops are formed as a mist and are suspended in the vapor stream. The velocity of the vapor stream is reduced as the vapor stream enters the gas/liquid separator 120, causing the liquid drops to fall out of the vapor stream. As an alternative, contacting the vapor stream with a metal mesh or corrugated metal placed inside the gas/liquid separator 120 may force liquid drops onto a cold metal surface to enhance separation. In one or more embodiments, the first separation apparatus 120 may comprise a separator that washes the vapor stream, such as a gas/liquid contactor, a spray tower or a scrubber.

Similarly, a second separation apparatus 152 may in one or more embodiments comprise a gas/liquid separator, or a series of two or more gas/liquid separators, configured to separate the second liquid FT hydrocarbon products, extractable from the second separation apparatus 152 via the second FT product outlet line 117, from second FT tail gas stream extractable from the second separation apparatus 152 via a second separation apparatus gas outlet line 141. In one or more embodiments, in the second separation apparatus 152, the second liquid FT hydrocarbon products are separated from the second FT tail gases. The separated second liquid FT hydrocarbon products, exit from the second separation apparatus 152 via a second separation apparatus liquid outlet line 127. The separated second FT tail gas stream may exit the second separation apparatus 152 via the second separation apparatus gas outlet line 141. The second separation apparatus 152 may include a gas/liquid separator, which may comprise any separator known in the art to be operable to separate liquid hydrocarbons from gaseous components within the second FT product introduced thereto via the second FT product outlet line 117. The gas/liquid separator of the second separation apparatus 152 may be any separator known in the art to be operable to separate liquid hydrocarbons from gaseous components within the FT product introduced thereto via line 117. In one or more embodiments, the gas/liquid separator is selected from the group consisting of knock out drums and/or scrubbers.

Other System Components

As depicted in FIG. 1, in one or more embodiments, the Fischer-Tropsch reactor cascade system of the present disclosure may further comprise a syngas production apparatus 40, configured to produce synthesis gas (or “syngas”). The syngas production apparatus 40 may be one or more of any synthesis gas production apparatus known in the art. In one or more embodiments, the syngas production apparatus 40 may be selected from any syngas production equipment suitable for the selected feedstock and other plant conditions and may include for example reformers (including but not limited to steam reformers, autothermal reformers, partial oxidation reformers and hybrid reformers), gasifiers, and combinations thereof. A carbonaceous feed inlet line 35 is configured for introduction of a carbonaceous feed material into the syngas production apparatus 40. One or more reactant supply lines 34 may configured to introduce a reactant, such as oxygen, oxygen-enriched air, and/or steam into the syngas production apparatus 40, although the reactant may, in one or more embodiments, be combined with the carbonaceous material prior to introduction into the syngas production apparatus 40. A syngas production apparatus outlet line 45 is configured to extract synthesis gas from syngas production apparatus 40. The synthesis gas as it exits from the syngas production apparatus 40 may be “dirty,” that is, the synthesis gas may contain one or more undesired contaminant, such as water, carbon dioxide, hydrogen sulfide or other components that may not be wanted to be included in the synthesis gas used as an input to an FT reactor. In addition, in some cases, the ratio of hydrogen to carbon monoxide in the synthesis gas may not be optimal, with the synthesis gas containing as it exits from the syngas production apparatus 40 more hydrogen or more carbon monoxide than is optimal.

In one or more embodiments, the synthesis gas production apparatus 40 is configured to produce syngas from a carbonaceous material selected from biomass, natural gas, associated gas, coal-bed methane, residual oil fraction(s), coal, and combinations thereof. In one or more embodiments, the syngas production apparatus 40 is configured to produce syngas from light hydrocarbons, including methane and/or other hydrocarbons in natural gas, by means of various reforming processes, including steam reforming, auto-thermal reforming, dry reforming, advanced gas heated reforming, and/or by partial oxidation (e.g., catalytic partial oxidation). In one or more embodiments, the syngas production apparatus 40 is configured to produce synthesis gas via the gasification of biomass and/or coal.

Continuing to refer to FIG. 1, in one or more embodiments, the Fischer-Tropsch reactor cascade system of the present disclosure may comprise a first temperature adjuster H1 configured either to heat or to cool the ‘dirty’ synthesis gas produced in syngas production apparatus 40 prior to introduction of the temperature adjusted ‘dirty’ synthesis gas into a syngas clean-up apparatus 50.

In embodiments where the temperature adjuster H1 comprises a cooler, the cooler may operate via heat transfer from a cooled material (e.g., boiler feed water (“BFW”) entering on first temperature adjuster input line 1, as indicated in FIG. 1. A stream C (that may be known as waster heat boiler water or economizer) may be extracted from the temperature adjuster H1 via a first temperature adjuster outlet line 2, as indicated in FIG. 1.

In one or more embodiments, the temperature adjuster H1 comprises a cooler that lowers the temperature of the ‘dirty’ syngas introduced thereto via the syngas production apparatus outlet line 45 to a temperature of about 90° C., 80° C., or 70° C. or lower, for example, for a RECTISOL™ pre-wash.

In one or more embodiments, the temperature adjuster H1 comprises a heater that elevates the temperature of the ‘dirty’ syngas introduced thereto via the syngas production apparatus outlet line 45 to a temperature of at least about 200° C., 400° C., or 600° C., as is the case for the RTI-Eastman chemical technology.

Continuing to refer to FIG. 1, the temperature-adjusted synthesis gas may exit the temperature adjuster H1. In one or more embodiments, the output of the temperature adjuster H1 may be fluidly connected to a synthesis gas cleanup apparatus 50 via a first temperature adjuster outlet line 46. (In embodiments lacking a first temperature adjuster H1, the synthesis gas cleanup apparatus 50 may be connected directly or indirectly to the syngas production apparatus 40 via the syngas production apparatus outlet line 45.) The syngas clean-up apparatus 50 may comprise any apparatus known in the art to be suitable for removing one or more undesired contaminants from the synthesis gas produced in syngas production reactor 40. In one or more embodiments, the degree of cleaning performed in the syngas clean-up apparatus 50 is less than in conventional FT systems that lack a first (or ‘guard bed’) FT reactor 100 that is upstream of a second FT reactor 150 with a second FT catalyst, the first FT reactor 100 having has a first FT catalyst and a first heat transfer surface area to catalyst volume ratio that is less than a second heat transfer surface area to catalyst volume ratio of the second FT reactor 150.

In one or more embodiments, the syngas clean-up apparatus 50 is configured to reduce the amount of hydrogen sulfide in the synthesis gas introduced thereto. In one or more embodiments, the syngas clean-up apparatus 50 is configured to reduce the amount of carbon dioxide in the synthesis gas introduced thereto. The syngas clean-up apparatus 50 may comprise, for example, an add gas removal unit operable to reduce the level of hydrogen sulfide, ammonia, and/or carbon dioxide in the synthesis gas introduced thereto. In one or more embodiments, syngas clean-up apparatus 50 comprises one or more apparatus selected from the group consisting of zinc oxide beds, SELEXOL® units, and RECTISOL™ units.

In one or more embodiments, the syngas clean-up apparatus 50 comprises a zinc oxide bed configured for the removal of hydrogen sulfide via adsorption thereof. In one or more embodiments, the syngas clean-up apparatus 50 comprises a SELEXOL® unit. SELEXOL® units operate via a physical separation that does not rely on a chemical reaction. The SELEXOL® solvent is an add gas removal solvent (specifically, a mixture of dimethyl ethers of polyethylene glycol) frequently utilized to separate acid gases such as hydrogen sulfide and carbon dioxide from feed gas streams (i.e., syngas), such as, but not limited to, those produced via the gasification of coal, coke, and/or heavy hydrocarbon oils. In one or more embodiments, the syngas clean-up apparatus 50 comprises a RECTISOL™ unit. Like SELEXOL® units, RECTISOL™ units operate via a physical, rather than a chemical, separation. RECTISOL™ units utilize methanol as a solvent to separate acid gases such as hydrogen sulfide and carbon dioxide from valuable feed gas streams. RECTISOL™ units are frequently utilized to treat gas streams (i.e., syngas) produced by the gasification of coal and/or heavy hydrocarbons, as the methanol solvent is operable to remove trace contaminants such as ammonia, mercury, and hydrogen cyanide commonly present in such product gas streams. In one or more embodiments, the syngas clean-up apparatus 50 is configured to reduce the level of H₂S in the synthesis gas extracted therefrom, for example via a fresh synthesis gas feed line 105, to less than about 1, 0.5 or 0.1 ppm. In one or more embodiments, the syngas clean-up apparatus 50 is configured to reduce the level of CO₂ in the synthesis gas extracted therefrom, for example via the first fresh synthesis gas feed line 105, to less than about 5000, 1000 or 500 ppm. The synthesis gas exiting from the syngas clean-up apparatus 50 may be referred to as “clean” or “fresh” synthesis gas.

In one or more embodiments, the syngas clean-up apparatus 50 is includes equipment to adjust the amount of hydrogen in the synthesis gas. For example, the syngas clean-up apparatus 50 may comprise a membrane designed for removing excess hydrogen from the synthesis gas introduced thereto.

In one or more embodiments, the fresh synthesis gas feed line 105 is configured to introduce a first feed syngas, including at least a first portion of the fresh synthesis gas to the first FT reactor 100, either directly, or as indicated in FIG. 1, after passage through a second temperature adjuster H2. In addition to the fresh synthesis gas, the first feed gas may comprise additional input gas introduced to the fresh synthesis gas feed line 105 from a fourth recycle line 145, a first supplemental gas line 36 and/or a first recycle line 135, as further discussed herein. In one or more embodiments, the second temperature adjuster H2 comprises a heater (“second heater H2”) that elevates the temperature of the first feed gas to a temperature of at least or about 120° C., 140° C., or 200° C. In one or more embodiments, the second heater H2 elevates the temperature of the first feed gas from a temperature in the range of from about 10° C. to about 100° C., from about 20° C. to about 80° C., or from about 30° C. to about 75° C., to a temperature in the range of from about 160° C. to about 220° C., from about 170° C. to about 200° C., or from about 180° C. to about 190° C. In such embodiments, the second heater H2 may operate via heat transfer from a hot material (e.g., steam S entering on a second temperature adjuster input line 3) or the heater may generate heat from a fuel. A condensate C comprising cooled heating material (e.g., water or reduced temperature steam) may be extracted from the second heater H2 via a second temperature adjuster discharge line 4, as indicated in FIG. 1. In other embodiments, the second temperature adjuster H2 may comprise a cooler.

As mentioned above, at least the first portion of the fresh synthesis gas in the fresh synthesis gas feed line 105 is introduced into the first FT reactor 100. A second fresh synthesis gas line 107 may be configured to introduce a second portion of fresh synthesis gas from the fresh synthesis gas feed line 105 into the second FT reactor 150. In this manner, and as discussed further herein below, the molar ratio of hydrogen to carbon monoxide in the feed streams to the first FT reactor 100 and/or the second FT reactor 150 can be maintained at a desired value, e.g., just below stoichiometric.

As described above, in operation, the first FT reactor 100 has a first FT catalyst and a first S/V that differs from a second S/V of a downstream second FT reactor having a second catalyst. In embodiments, the first and second catalysts may be different of the same.

Although the embodiment(s) depicted in FIG. 1 include one first FT reactor 100 and one second FT reactor 150, in one or more embodiments, the Fischer-Tropsch reactor cascade system of the present disclosure may comprise a first FT stage and a second FT stage wherein either or both the first FT stage and the second FT stage comprises more than one FT reactor. In such embodiments, one FT reactor 100 or a plurality of first FT reactors 100 in parallel or in series comprise a first FT stage, with each first FT reactor 100 having a first FT catalyst and a first S/V. The downstream second FT stage may comprise a one or a plurality of second FT reactors 150 in parallel or in series, with each second FT reactor 100 having a second FT catalyst and a second S/V that is different than the first S/V. Such embodiments are discussed further herein below.

Continuing to refer to FIG. 1, in one or more embodiments as mentioned above, the Fischer-Tropsch reactor cascade system of the present disclosure may further comprise the first recycle line 135 fluidly connecting a first separation apparatus gas outlet line 131 with the first FT reactor 100 via, for example, a connection with the fresh synthesis gas feed line 105, whereby a first portion of a first FT tail gas stream, including unspent synthesis gas, separated from a first liquid FT product by a first separation apparatus 120 may be re-introduced as part of a first feed into the first FT reactor 100.

In one or more embodiments, the Fischer-Tropsch reactor cascade system of the present disclosure may further comprise a second recycle line 143 fluidly connecting a second separation apparatus gas outlet line 141 with either or (as depicted in FIG. 1) both the first FT reactor 100 and the second FT reactor 150. Via the second recycle line 143, a first portion of a second FT tail gas stream, including unspent synthesis gas, separated from a second liquid FT product in a second separation apparatus 152 may be (i) re-introduced into the second FT reactor 150 as part of a second reactor feed via a third recycle line 144, such as by the third recycle line 144 fluidly connecting with the first separation apparatus gas outlet line 131; and/or (ii) reintroduced onto the first FT reactor 100 as part of the first reactor feed, such as via the fourth recycle line 145 that is fluidly connected with the first fresh synthesis gas feed line 105. In one or more embodiments of the present disclosure, additional amounts of hydrogen or another gas (if any) may introduced into the first feed of the first FT reactor 100 via a first supplemental gas line 36 and/or introduced into the second FT reactor 150 via a second supplemental gas line 37.

As discussed further herein below, in embodiments each of the following may be adjusted, singly or in one or more combinations, to provide a desired molar ratio of hydrogen to carbon monoxide in the feed to each FT reactor: (1) the extent (if any) of recycle (a) to the first FT reactor 100 via lines 135 and/or 145, and/or (b) to the second FT reactor 150 via line 144; (2) the amount of fresh synthesis gas (a) introduced to the first FT reactor 100 via the fresh synthesis gas feed line 105 and/or (b) introduced into the second FT reactor 150 via the synthesis gas fresh feed line 107, and/or (3) the amount of hydrogen or other gas (if any) (a) Introduced into the first FT reactor 100 via the first supplemental gas line 36 and/or (b) introduced into the second FT reactor 150 via the second supplemental gas line 37.

For embodiments wherein the second heat transfer surface area to catalyst volume of the second FT reactor 150 is greater than the first heat transfer surface area to catalyst volume ratio of the first FT reactor 100, the introduction of fresh synthesis gas directly to the second FT reactor 150 increases the risk of poisoning the second catalyst used for the second FT reactor 150 since the fresh synthesis gas has not gone through the first FT reactor 100. In such embodiments, a conservative approach may be warranted with respect to how much fresh synthesis gas is introduced into the second FT reactor 150.

The amount of fresh synthesis gas introduced into the first FT reactor 100 via the fresh synthesis gas feed line 105 and the amount (if any) of fresh synthesis gas introduced into the second FT reactor 150 via the second fresh synthesis gas line 107 may be adjusted as desired. For example, for embodiments wherein the second heat transfer surface area to catalyst volume of the second FT reactor 150 is greater than the first heat transfer surface area to catalyst volume ratio of the first FT reactor 100, should the synthesis gas contain relatively little contaminant, a greater portion of the fresh synthesis gas may be directed to the second FT reactor 150 than when the fresh synthesis gas comprises substantial contaminants.

In one or more embodiments wherein the first S/V is less than the second S/V, the first FT reactor 100 is operated to provide from about 0 to about 100 percent, from about 10 to about 90 percent, from about 10 to about 80 percent, or from about 10 to about 70 percent of the overall carbon monoxide converted. In one or more embodiments, the second FT reactor 150 is operated to provide from about 0 to about 100 percent, from about 10 to about 90 percent, from about 20 to about 90 percent, or from about 30 to about 90 percent of the overall carbon monoxide converted. In one or more embodiments, the first FT reactor 100 is operated to provide less than or equal to about 50 percent of the overall carbon monoxide converted and the second FT reactor 150 is operated to provide the other more than or equal to about 50 percent of the overall carbon monoxide converted. In one or more embodiments, the first FT reactor 100 is operated to provide less than or equal to about 40 percent of the overall carbon monoxide converted and the second FT reactor 150 is operated to provide the other more than or equal to about 60 percent of the overall carbon monoxide converted. In one or more embodiments, the first FT reactor 100 is operated to provide less than or equal to about 30 percent of the overall carbon monoxide converted and the second FT reactor 150 is operated to provide the other more than or equal to about 70 percent of the overall carbon monoxide converted. Depending on the make-up of available synthesis gas, the first FT reactor 100 or the second FT reactor 150 may be utilized to provide the entirety of the conversion at various times. The amount of conversion effected by each FT reactor may be altered depending on the available synthesis gas feed.

Although not depicted in the embodiment(s) of FIG. 1, in one or more embodiments of the present disclosure, one or more recycle lines may be configured to introduce a portion of the gas extracted from the first or second separation apparatus 120, 152, or both into the synthesis gas production apparatus 40. For example, a fifth recycle line 133 might fluidly connect the first separation apparatus gas outlet line 131 with an Input of the synthesis gas production apparatus 40, whereby additional synthesis gas may be produced from the light hydrocarbons in a portion of the first FT tail gas stream. A light Fischer-Tropsch liquids (LFTL) separator output line 166, further described herein below, may fluidly connect the gaseous output of an LFTL separator 122 (which, as discussed below, may comprise a knockout drum) with an input for the syngas production apparatus 40, whereby additional synthesis gas may be produced therefrom. In one or more embodiments, the disclosed system provides for separating light Fischer-Tropsch liquids (LFTL) from a portion of the gas separated in the first separation apparatus 120, at least a portion of the gas separated in the second separation apparatus 152, or portions of both. For example, a portion of the gas separated in the first separation apparatus 120 may be Introduced via the fifth recycle line 133 into a chiller C3 and then to the LFTL separator 122. Alternatively or additionally, at least a portion of the gas separated from the FT liquid products via the second separation apparatus 152 may be introduced via a second feedline 142 into the LFTL separator 122.

In one or more embodiments, the LFTL separator 122 may be configured to separate a FT tail gas from condensed LFTL (“CLFTL”) (and in such embodiments may be referred to as a “CLFTL separator 122”). The CLFTL extracted via the LFTL product line 167 (which may be called in such embodiments, the “CLFTL product line” 167) may be characterized by a hydrocarbon mixture obtain when using a refrigerant like propane, which allows condensation of C₃, C₄, C₅, C₆ linear and isomers, especially when the condensation takes place under pressure. In one or more embodiments, the LFTL separator 122 is replaced by an oil contactor so that the CLFTL is dissolved in re-circulated oil. The FT tail gas extracted via the LFTL separator output line 166 may be characterized by unreacted hydrogen, carbon monoxide, methane, carbon trioxide and light hydrocarbons. The hydrocarbon contact depends on the temperature of the chiller C3 and the subsequent LFTL separator 122. Typically, the FT tail gas extracted via the LFTL separator output line 166 will contain methane, ethane, ethylene, propane and propene, with small amounts of butanes and pentanes. In one or more embodiments, the CLFTL's are condensed at a temperature of less than or equal to about 4° C., 0° C., or −10° C. In such a case, a water removal step may be necessary to avoid water freezing within the equipment. Within a CLFTL separator 122, CLFTL's are separated from an uncondensed FT tail gas. As mentioned hereinabove, it is envisioned that a portion of the FT tail gas extracted from the CLFTL separator 122 via the LFTL separator output line 166 may be recycled to the first FT reactor 100, the second FT reactor 150, synthesis gas production apparatus 40, or a combination thereof. CLFTL may be extracted from CLFTL separator 122 via CLFTL product line 167.

As noted hereinabove, FT products produced via the disclosed system and method may be further upgraded as known in the art. For example, in one or more embodiments, the method further comprises upgrading and/or separating one or more desired products produced in the first FT reactor 100 and/or the second FT reactor 150. In embodiments, hydrotreatment and distillation are utilized to provide desired products from the FT products in the first separation apparatus liquid outlet line 125, the second separation apparatus liquid outlet line 127, the CLFTL product outlet line 167, or a combination or any two or all three thereof. In one or more embodiments, the FT liquid product produced in the first FT reactor 100 and/or the second FT reactor 150 is upgraded to provide one or more products selected from primarily FT naphtha, primarily FT diesel, FT drilling fuel, primarily FT jet fuel, primarily lubricants, or a combination of any two or more of FT naphtha, FT diesel, FT jet fuel, lubrication oils and FT wax.

In one or more embodiments and as mentioned above, from the syngas clean-up apparatus 50, the first feed gas, which might include additions from the first supplemental gas line 36, the first recycle line 135, and/or the fourth recycle line 145, passes through the second temperature adjuster H2, which may be configured for heating the first feed gas prior to being introduced into the first FT reactor 100. The first FT reactor 100 operates at suitable FT conditions with a first FT catalyst to produce first FT products from the feed gas including clean synthesis gas. To achieve suitable FT conditions, the first FT reactor 100 is operable with a heat transfer apparatus (as previously discussed with respect to the first steam drum 101 of FIG. 1) configured to maintain a desired reaction temperature, as known in the art. For example, as indicated in FIG. 1, boiler feed water, BFW, from a BFW line 54 may be preheated via heat transfer with steam S, for example, in a first steam drum 101 and passed through the shell side of the first FT reactor 100 (e.g., passed outside the heat transfer tubes of the first FT reactor 100) and steam may be extracted from the first FT reactor 100 (e.g., extracted at the outlet of the shell side of the first FT reactor 100 via a first shell side output line 61) and passed through the first steam drum 101 to preheat additional BFW and out via a first steam line 55. Additional steam S may be introduced to the reactor directly, in one or more embodiments, such as through a first supplemental steam line 53 as indicated in the embodiment of FIG. 1. Such heat transfer systems are well known in the art.

The first FT products produced in the first FT reactor 100 comprise liquid hydrocarbons, vaporous hydrocarbons and unreacted synthesis gas. The first FT products of the first FT reactor 100 comprises a substantial quantity of high molecular weight hydrocarbons, generally from about C5 to about C100, or larger. The liquid FT products are a mixture of hydrocarbons that is the result of a block of —CH₂— and it grows with a growth probability factor called an alpha value between 0.8 to 0.97, according to the Anderson-Schulz-Flory distribution.

As depicted in FIG. 1, in one or more embodiments, the Fischer-Tropsch reactor cascade system of the present disclosure further comprises a fluid connection between the first FT reactor 100 and the second FT reactor 150, whereby unreacted synthesis gas exiting the first FT reactor 100 may be introduced into the second FT reactor 150. In the embodiment(s) of FIG. 1, the first FT reactor 100 is fluidly connected with the second FT reactor 150 via the first FT reactor product outlet line 115, the first separation apparatus 120, and the first separation apparatus gas outlet line 131. In such embodiments, the first d FT hydrocarbon products extracted from the first FT reactor 100 via first product outlet line 115 may pass through the first cooler C1, which cools the first FT hydrocarbon products before the first FT hydrocarbon products are Introduced into the first separation apparatus 120. For example, the liquid FT hydrocarbon products may be cooled and separated from a FT reaction temperature of greater than or equal to about 180° C., 200° C., or 220° C. to a temperature of less than or about equal to 100° C., 25° C., or 10° C. The first cooler C1 may operate via the transfer of heat from the first FT hydrocarbon products to coolant (e.g., boiler feed water or ‘BFW’) introduced thereto via a first BFW line 5 and may be discharged via a first cooler discharge outlet 6.

As described above, within the separation apparatus 120, the liquid FT hydrocarbon products are separated from first FT tail gas. In one or more embodiments, as depicted in FIG. 1, a single first cooler C1 and a first separation apparatus 120 are used. In one or more embodiments, this combination of cooler-separator is repeated so that the system contains two or more sets in series. The more coolers and separators that are used, the more hydrocarbons are condensed and cooler the first liquid FT hydrocarbon products and the first FT tail gas within first product outlet line 115 become.

The first liquid FT hydrocarbon products are extracted from the first separation apparatus 120 via the first FT liquid product line 125. In one or more embodiments, the first liquid FT hydrocarbon products extracted via the first FT liquid product line 125 comprise primarily C₅+ hydrocarbons. In one or more embodiments, with more than one set of the cooler-separator combination, the first separation apparatus 120 will condense a heavier cut of the first liquid FT hydrocarbon products than the subsequent separators in series with the first separation apparatus 125.

The first FT tail gas separated from the first liquid FT hydrocarbon products within the first separation apparatus 120 is extracted in a stream via a first separation apparatus gas outlet line 131. The first FT tail gas stream extracted from the first separation apparatus 120 via the first separation apparatus gas outlet line 131 comprises unreacted synthesis gas and may further comprise carbon dioxide, and/or low molecular weight hydrocarbons. In one or more embodiments, the unreacted synthesis gas of the first FT tail gas extracted via the first separation apparatus gas outlet line 131 has a molar ratio of hydrogen to carbon monoxide that is in the range of from about 0.9 to about 2.2, from about 1.2 to about 2, or from about 13 to about 1.7. In one or more embodiments, the unreacted synthesis gas of the first FT tail gas extracted via the first separation apparatus gas outlet line 131 has a molar ratio of hydrogen to carbon monoxide that is greater than or equal to about 0.7:1, greater than or equal to about 0.8:1, greater than or equal to about 0.9:1, or greater than or equal to about 1:1. In one or more embodiments, the unreacted synthesis gas of the first FT tail gas extracted via the first separation apparatus gas outlet line 131 comprises less than about 10 ppb, 2 ppb, or 0.1 ppb hydrogen sulfide, as the first FT reactor 100 has served not only to as a production reactor, producing FT hydrocarbons, but has also served to clean the unreacted synthesis gas prior to introduction into the second FT reactor 150.

In one or more embodiments, a first portion of the separated first FT tail gas stream in the first separation apparatus gas outlet line 131 may be recycled to become part of the feed for the first FT reactor 100 via the first recycle line 135. At least a second portion of the separated first FT tail gas stream from the first separation apparatus 120 is introduced via the first separation apparatus gas outlet line 131 into the second FT reactor 150, as a least a part of a second feed gas. In addition to the second portion of the separated first FT tail gas stream, the second feed gas may include the second portion of the fresh synthesis gas feed in the second fresh synthesis gas line 107, at least a portion of a second FT tail gas stream recycled from the second FT reactor 150 after separation by a second separation apparatus 152 via a second recycle line 143 and a third recycle line 144, additional gas (such as, but not limited to, FT tail gas from the LFTL separator output line e 166, and/or hydrogen and/or nitrogen) in a second supplemental feed line 37, or a combination thereof, which may be combined with the synthesis gas in line 131. In one or more embodiments, hydrogen and/or nitrogen may be introduced into the second FT reactor 150 via the second supplemental feed line 37. In one or more embodiments, no fresh synthesis gas is introduced into the second FT reactor 150 via the second fresh synthesis gas line 107, and all of the fresh synthesis gas is passed through the first FT reactor 100.

In one or more embodiments and as mentioned above, from the first separation apparatus 120, the second portion of the fresh synthesis gas, with or without additions from the second supplemental feed line 37, the second fresh synthesis gas line 107, and/or the third recycle line 144, passes through a third heater H3 configured for heating the second feed gas prior to the second feed gas being introduced into the second FT reactor 150.

As depicted in of FIG. 1, in one or more embodiments, the third heater H3 may operate via heat transfer from an elevated temperature heating material (e.g., steam S added via a third steam input line 7, as indicated in FIG. 1). A condensate C comprising cooled heating material (e.g., water or reduced temperature steam) may be extracted from the third heater H3, via a third steam discharge line 8, as indicated in FIG. 1. In one or more embodiments, the third heater H3 elevates the temperature of the second feed gas introduced thereto via the first separation apparatus gas outlet line 131 and optionally via the second fresh synthesis gas feed line 107, the third recycle line 144 and/or the second supplemental gas line 37 to a temperature of at least or about 200° C., 220° C., or 230° C. In one or more embodiments, the third heater H3 elevates the temperature of the feed gas introduced thereto from a temperature in the range of from about 20° C. to about 200° C., from about 20° C. to about 100° C., or from about 20° C. to about 60° C., to a temperature in the range of from about 180° C. to about 230° C., from about 190° C. to about 210° C., or from about 200° C. to about 210° C. It is also envisaged that, in one or more embodiments, one or more heaters may be utilized to heat the gas in one or more of lines 131, 107, 144, and/or 37, separately, or with combination of two or more of the streams prior to heating.

As with the first FT reactor 100, the second FT reactor 150 is operable with the second FT catalyst at second FT conditions with a second heat transfer apparatus configured to maintain a desired reaction temperature, as known in the art. For example, as indicated in the embodiment of FIG. 1, boiler feed water, BFW, introduced through a third BFW line 57, may be preheated via heat transfer with, for example, steam S added through a fourth steam input line 66, in a second steam drum 102 and passed through the second FT reactor 150 (e.g., passed through the shell outside the heat transfer tubes of the vessel) via a second shell side input line 59. Steam may be extracted from the shell side of the second FT reactor 150 (e.g., extracted at the outlet of the shell side of the vessel) via a second shell side output line 65 and passed through the second steam drum 102 to preheat additional BFW. Additional steam S may be introduced to the reactor directly, in one or more embodiments, or indirectly such as through a second supplemental steam line 67, as indicated in the embodiment of FIG. 1. Such heat transfer systems are well known in the art and will thus not be described in detail herein.

In one or more embodiments, the second FT reactor 150 operates at suitable second FT conditions with a second FT catalyst (the first FT reactor being operated with the first FT catalyst) to produce second FT products from the second feed. As previously mentioned, the second FT products produced in the second FT reactor 150 comprise second liquid FT hydrocarbons, a second FT tail gas stream and a second FT water stream. The second FT tail gas stream typically comprises vaporous FT hydrocarbons and unreacted synthesis gas. In one or more embodiments, the second FT hydrocarbons extracted from the second FT reactor 150 via the second FT product outlet line 117 are cooled by a second cooler C2 prior to separation of liquids and gases within the second separation apparatus 152. For example, the second FT hydrocarbons may be cooled from a FT reaction temperature of greater than or equal to about 180° C., 200° C., or 220° C. to a temperature of less than or about equal to 100° C., 25° C., or 10° C. The second liquid FT products are extracted from the second separation apparatus 152 via a second FT liquid product line 127. In one or more embodiments, the second liquid FT products extracted via the second FT liquid product line 127 comprise primarily C₅ hydrocarbons. The second cooler C2 may operate via the transfer of heat from the second liquid FT hydrocarbon products and the second FT tail gas to a coolant (e.g., BFW). The coolant may be introduced to the second cooler C2 via a second BFW line 9 and may be discharged via a second cooler discharge line 10.

In one or more embodiments as depicted in FIG. 1, the second FT tail gas stream is extracted from the second separation apparatus 152 via a second separation apparatus gas outlet line 141. The second FT tail gas stream extracted from the second separation apparatus 152 via the second separation apparatus gas outlet line 141 may comprise unreacted synthesis gas and may further comprise carbon dioxide, and/or low molecular weight hydrocarbons. In one or more embodiments, the second separation apparatus gas outlet line outlet line 141 may supply the second FT tail gases (1) via the third recycle line 144 and the second recycle line 143 to augment the second feed into the second FT reactor 150 and/or (2) via the second recycle line 143 and the fourth recycle line 145 to augment the first feed into the first FT reactor 100. The second separation apparatus gas outlet line 141 and the second feedline 142 may convey all or a portion of the second FT tail gases stream to a separator 122. In one or more embodiments, as depicted in FIG. 1, prior to entering the separator 122, the second FT tail gases stream may be augmented by FT gas carried via the fifth recycle line 133 from the first separation apparatus 120. Before entering the separator 122. The second FT tail gas stream, whether augmented or not, may pass through a third cooler C3. The third cooler C3 may be configured with for example BFW from a BFW line 11 to cool the gases introduced thereto via the second feedline 142 and/or the fifth recycle line 133 prior to introduction of the cooled gas into the separator 122. The separator 122 may comprise, for example, an LFTL knock-out drum, as known in the art. An LFTL product line 167 may be configured to extract LFTL from the separator 122 and transport it to storage or to further processing, such as distillation or hydrotreating reactors. The LFTL separator output line 166 may be configured to extract FT tail gas from separator 122. The third cooler C3 upstream of the separator 122 may operate via the transfer of heat from the second FT tail gases (whether augmented or not) to coolant such as chilled water or glycol introduced thereto via a third coolant inlet line 11 and may be discharged via a third cooler discharge line 12. The cooler C3 may cool the gas introduced thereto to a temperature of less than or equal to about 0° C., 10° C., or 25° C. In one or more embodiments, the cooler C3 cools a gas introduced thereto at a temperature in the range of from about 80° C. to about 150° C., from about 100° C. to about 150° C., or from about 80° C. to about 150° C., to a temperature in the range of from about 0° C. to about 25° C., from about 0° C. to about 20° C., or from about 15° C. to about 20° C.

As noted hereinabove, the fifth recycle line 133 may fluidly connect first separation apparatus 120 with separator 122, whereby a portion of the first gas FT products separated from the first liquid FT products in the first separation apparatus 120 may be introduced into the separator 122. The second separation apparatus gas outlet line 141 and the second feedline 142 may fluidly connect the second separation apparatus 152 with the separator 122, whereby a portion of the second gas FT products separated from the second liquid FT products in the second separation apparatus 152 may be introduced into the separator 122. As mentioned hereinabove, the output of the separator 122 may be fluidly connected with the syngas production apparatus 40, whereby at least a portion of the FT tall gas extracted from the separator 122 via the LFTL separator output line 166 may be utilized by the syngas production apparatus 40 to produce additional synthesis gas. Alternatively or additionally, the separator 122 may be fluidly connected with inputs of the first FT reactor 100 and/or the second FT reactor 150, whereby at least a portion of the FT tail gas extracted via the LFTL separator output line 166 may be introduced into the first FT reactor 100, the second FT reactor 150, or both, for example, via the first supplemental gas line 36 and/or the second supplemental gas line 37.

One or more supplemental gas lines, such as but not limited to first and/or second supplemental gas lines 36, 37, may be utilized to introduce additional feed gas into the first FT reactor 100 and/or the second FT reactor 150, respectively. For example, the first supplemental gas line 36 and/or the second supplemental gas line 37 may be configured to introduce hydrogen, nitrogen, FT tail gas (e.g., via the LFTL separator output line 166) into the first FT reactor 100 and/or the second FT reactor 150, respectively. The introduction of additional hydrogen via the first supplemental gas line 36 and/or the second supplemental gas line 37 may be utilized to provide a desired molar ratio of hydrogen to carbon monoxide in the feed gas introduced into the first FT reactor 100 and/or the second FT reactor 150. In one or more embodiments, the Fischer-Tropsch reactor cascade system of the present disclosure may further comprise a hydrogen supply apparatus (not depicted in FIG. 1) configured to provide additional hydrogen for introduction via the first supplemental gas line 36 and/or the second supplemental gas line 37, for example, a hydrogen separation membrane, or a pressure swing adsorber (PSA), etc., as known in the art. In one or more embodiments, the Fischer-Tropsch reactor cascade system of the present disclosure comprises no additional hydrogen introduction lines and/or hydrogen production apparatus.

The Fischer-Tropsch reactor cascade system of the present disclosure may further comprise downstream FT product upgrading equipment. As such product upgrading equipment is known in the art, details of such equipment will not be provided here. For example, in one or more embodiments, the Fischer-Tropsch reactor cascade system of the present disclosure further comprises one or more apparatus selected from hydrolsomerisers, hydrotreaters, distillation apparatus, and other known upgrading and/or separation apparatus, configured to upgrade and/or separate FT products into one or more desirable components, including, but not limited to, FT diesel, FT jet, FT naphtha and FT waxes. For example, upgrading apparatus may be configured to produce paraffins from olefins in one or more of the FT product streams within the first separation apparatus liquid outlet line 125, the second separation apparatus liquid outlet line 127, and the LFTL product line 167.

The Fischer-Tropsch reactor cascade system of the present disclosure may further comprise various heaters and coolers, as known in the art. For example, as mentioned hereinabove, the Fischer-Tropsch reactor cascade system of the present disclosure may comprise a temperature adjuster H1, which may comprise a heater exchanger configured to heat or cool the ‘dirty’ synthesis gas prior to introduction into syngas clean-up apparatus 50. The Fischer-Tropsch reactor cascade system of the present disclosure may also comprise the second temperature adjuster H2 configured to heat the feed gas introduced into the first FT reactor 100, and/or a third temperature adjuster H3 configured to heat the feed gas introduced into the second FT reactor 150, or a combination thereof. As noted hereinabove, the Fischer-Tropsch reactor cascade system of the present disclosure may comprise a first cooler C1 configured to cool the FT products extracted from the first FT reactor 100 prior to separation in the first separation apparatus 120, a second cooler C2 configured to cool the FT products extracted from the second FT reactor 150 prior to separation in the second separation apparatus 152, a third cooler C3 configured to cool the synthesis gas containing stream(s) introduced thereto via the second feedline 142 and/or the fifth recycle line 133 prior to introduction thereof into the separator 122, or a combination of two or more of coolers C1, C2, and C3.

As described hereinabove, the first and second FT reactors 100 and 150 comprise heat transfer apparatus for maintaining a desirable operation temperature therein, as well known in the art. For example, the first FT reactor 100, the second FT reactor 150, or both may contain heat transfer tubes configured for the introduction of coolant thereto, whereby reaction heat is transferred to the coolant in the tubes and extracted from the reactor(s). For example, such heat transfer tubes may be configured to introduce water or some other suitable fluid into the reactor and for the extraction of steam therefrom. Such a heat transfer system may be associated with a reactor steam drum 101, 102, as known in the art, and described hereinabove. As such heat transfer apparatus is well known in the art, same will not be described herein in detail. In an alternative configuration the catalyst could be placed inside the tubes and the coolant be flowing in the outer shell of the reactor. The water vaporization would take place then in the shell side and transfer to the steam drum.

Other equipment, known in the art and not depicted in FIG. 1, may be used to provide transport or other unit operation, such as compressors, blowers, pumps, valves, exchangers, heaters, coolers, etc. As described or illustrated, system equipment may be fluidly connected with other equipment via any suitable piping, conduit, etc. as known to one of ordinary skill in the art, such as uni- or bi-directional inlet/outlet transfer lines. Although not depicted in FIG. 1, in one or more embodiments, the Fischer-Tropsch reactor cascade system of the present disclosure may be configured for convenient removal of water from any product stream or piece of equipment. For example, the Fischer-Tropsch reactor cascade system of the present disclosure may include transfer lines configured for the removal of unwanted or accumulated H₂O. In one or more embodiments, the Fischer-Tropsch reactor cascade system of the present disclosure includes one or more purge lines (not depicted in FIG. 1). Make-up or utility streams may be added as necessary or desired.

As discussed herein above, although the description has been made with respect to a single the first FT reactor 100 having a first FT catalyst and a first S/V upstream of a single downstream the second FT reactor 150 having a second FT catalyst and a second S/V that is different than the first S/V, it is to be understood that either the first and/or the second stage of the disclosed system may comprise a plurality of reactors. The plurality of reactors in each stage may be arranged in series and/or in parallel. For example, in one or more embodiments, a first stage may comprise two or more first FT reactors 100, each of the plurality of the first FT reactors 100 of the first stage being substantially as described with regard to the first FT reactor 100 hereinabove. In one or more embodiments, a first stage comprises a plurality of first FT reactors 100 aligned in series. In one or more embodiments, a first stage comprises a plurality of first FT reactors 100 arranged in parallel. In this manner, it may be feasible to have one or more first FT reactor(s) 100 of the plurality of first FT reactors 100 in the first stage online while another or more of the plurality of first FT reactors 100 is being subjected to catalyst rejuvenation, regeneration, or replacement. Similarly, a second stage of FT reactors 150 may be utilized, each of the plurality of second FT reactors 150 being substantially similar to the second FT reactor 150 described hereinabove. In one or more embodiments, a second stage of FT reactors comprises a plurality of second FT reactors 150 aligned in series. In one or more embodiments, a second stage of FT reactors comprises a plurality of second FT reactors 150 arranged in parallel. In this manner, it may be feasible to have one or more second FT reactor(s) 150 of the plurality of second FT reactors 150 in the second stage online while another or more of the plurality of second FT reactors 150 is being subjected to catalyst rejuvenation, regeneration, or replacement. In one or more embodiments, a first stage of first FT reactors comprises more FT reactors than a second stage of second FT reactors, with the synthesis gas separated from the first FT product of the first FT reactors of the first stage being routed into the smaller number of second FT reactors of the second stage.

It is also envisaged that, in one or more embodiments, the Fischer-Tropsch reactor cascade system of the present disclosure may comprise, instead of two (or more) FT reactors, a single FT reactor configured with multiple zones. For example, in one or more embodiments, a single, multi-zoned FT reactor comprises a first zone configured to provide a heat transfer surface area to catalyst volume ratio as described with regard to the first FT reactor 100 hereinabove and a second zone configured to provide a heat transfer surface area to catalyst volume as described with regard to the second FT reactor 150 hereinabove that is different from the heat transfer surface area to catalyst volume ratio of the first zone. In one or more embodiments, a single multi-zoned FT reactor comprises a first zone configured to provide a productivity (cc CO converted/cc catalyst/hour) as described with regard to the first FT reactor 100 hereinabove and a second zone configured to provide a productivity (cc CO converted/cc catalyst/hour) as described with regard to the second FT reactor 150 hereinabove.

The locations of introduced and withdrawn streams indicated in FIG. 1 are not meant to be limiting. For example, although FT products including hydrocarbons and unreacted synthesis gas are indicated as being withdrawn together from the bottom of first and second FT reactors 100 and 150, it is envisaged that the FT products may be removed elsewhere and/or separately. For example, in embodiments in which a slurry reactor is employed as the first FT reactor 100 and/or the second FT reactor 150, the slurry may be withdrawn at or near the top of the reactor. In such applications, the liquid FT hydrocarbons, and gas comprising unreacted synthesis gas and gaseous FT hydrocarbons may be separated from catalyst withdrawn in a withdrawn slurry stream. Catalyst may be recycled to the reactor and separated unreacted synthesis gas and liquid hydrocarbons handled as disclosed herein.

Methods for Producing FT Product Via FT Reactor Cascade.

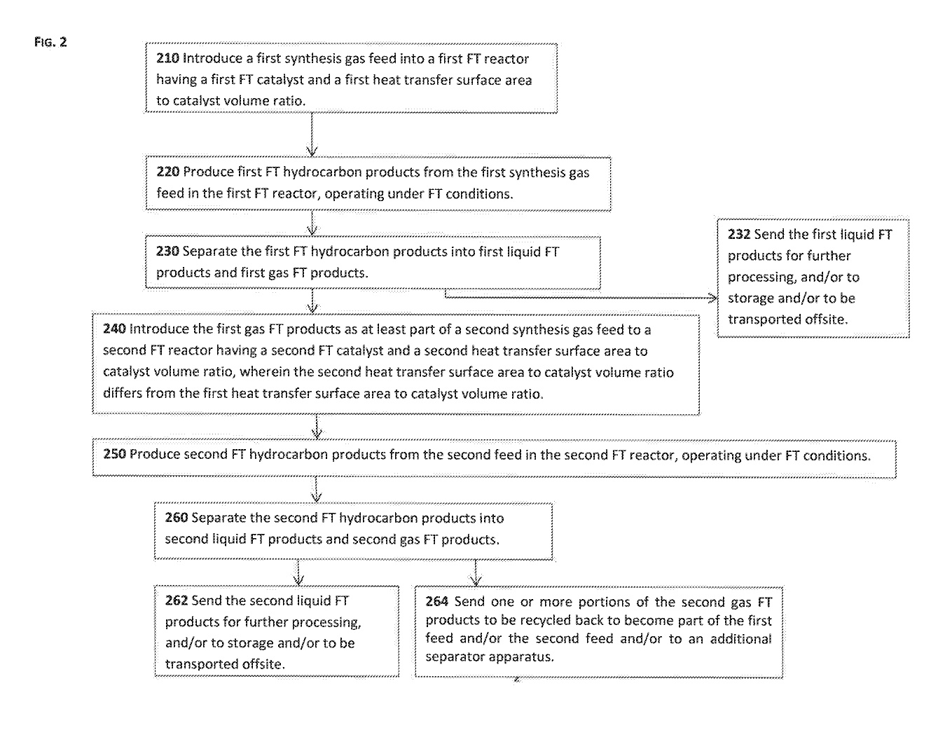

Also disclosed herein are methods of producing FT hydrocarbons via a FT reactor cascade. Referring now to FIG. 2, in one or more embodiments, a first synthesis gas feed is introduced 210 into a first FT reactor having a first FT catalyst and a first heat transfer surface area to catalyst volume ratio. In one or more embodiments, the first synthesis gas feed comprises hydrogen and carbon monoxide in a molar ratio of hydrogen to carbon dioxide of from about 1 to about 2.5, from about 1.5, to about 2.2, or from about 1.6 to about 1.9. In one or more embodiments, the first synthesis gas feed comprises hydrogen and carbon monoxide in a molar ratio of hydrogen to carbon dioxide of less than the stoichiometric ratio of about 2.1:1. In one or more embodiments, the first synthesis gas feed comprises hydrogen and carbon monoxide in a molar ratio of hydrogen to carbon dioxide of less than about 2.1:1, 1.8:1, or 1.6:1. In one or more embodiments, the first synthesis gas feed comprises hydrogen and carbon monoxide in a molar ratio of hydrogen to carbon dioxide of greater than about 1.4:1, 1.7:1, 1.8:1, or 1.9:1. The first synthesis gas feed may further comprise minor constituents, such as, but not limited to, light hydrocarbons, inert gases, N₂, ammonia, and sulfur-based components, such as, but not limited to, H₂S. In one or more embodiments, the first synthesis gas feed comprises less than or equal to about 100 ppb, 50 ppb, or 5 ppb hydrogen sulfide. In one or more embodiments, the first synthesis gas feed comprises greater than or equal to about 100 ppb, 50 ppb, or 5 ppb hydrogen sulfide.

For example, in one or more embodiments, the method of FIG. 2 may be used with the system of FIG. 1. As indicated in the embodiment of FIG. 1, the first synthesis gas feed of the one or more methods of FIG. 2 may comprise (1) fresh synthesis gas, such as from fresh synthesis gas feed line 105 in FIG. 1; (2) synthesis gas separated from a first FT product of the first FT reactor 100, such as that recycled via the first separation apparatus gas outlet line 131 and the first recycle line 135 in FIG. 1; (3) synthesis gas separated from a second FT product of the second FT reactor 150, such as that recycled via the second separation apparatus gas outlet line 141 and the third recycle line 144 in FIG. 1; and/or (4) hydrogen and/or other gas (such as FT tail gas recycled from the LFTL separator output line 166, Introduced via the first supplemental gas line 36 in FIG. 1); or a combination thereof. Desirably, the composition of the feed to the first FT reactor 100 is maintained at a molar ratio of hydrogen to carbon monoxide (H2:CO) that is less than, slightly less than, or about equal to the stoichiometric value of about 2.1:1. In one or more embodiments, the composition of the feed to the first FT reactor 100 is maintained at a molar ratio of hydrogen to carbon monoxide (H2:CO) that is in the range of from about 1.6:1 to about 2.2:1, from about 1.7:1 to about 2.1:1, from about 1.8:1 to about 2.1:1, or from about 1.6 to about 1.7. In one or more embodiments, the feed gas introduced into the first FT reactor 100 has a molar H2:CO ratio that is greater than or equal to about 1.6:1, 1.7:1, 1.8:1, 1.9:1, 1.95:1, or 2.0:1. Hydrogen may be introduced, in one or more embodiments, for example via first supplemental gas line 36, to adjust the molar ratio of hydrogen to carbon monoxide in the feed to the first FT reactor 100. In one or more embodiments, the overall feed gas introduced into the first FT reactor 100 comprises a total of less than or equal to about 100 ppb, 40 ppb, or 2 ppb hydrogen sulfide. In one or more embodiments, the overall feed gas introduced into the first FT reactor 100 comprises a total of greater than or equal to about 100 ppb, 40 ppb, or 2 ppb hydrogen sulfide.

Referring again to FIG. 2, the first FT reactor, operating under FT conditions, produces 220 first FT hydrocarbon products from the first synthesis gas feed. The first FT hydrocarbon products may range from methane to high molecular weight hydrocarbons comprising, for example, 100+ carbon atoms. In one or more embodiments, as mentioned hereinabove, the first FT reactor 100 is operated such that the catalyst productivity is less than about 300, 250, or 200 cc CO/cc catalyst/hour. In one or more embodiments, the first FT reactor 100 is operated at a temperature in the range of from about 160° C. to about 230° C., from about 180° C. to about 220° C., or from about 180° C. to about 190° C. In one or more embodiments, the first FT reactor 100 is operated at a pressure in the range of from about 200 psig to about 600 psig, from about 200 psig to about 500 psig, or from about 350 psig to about 450 psig. In one or more embodiments, the first FT reactor 100 is operated with a pressure drop across the reactor of less than about 3, 2, or 1 psi per foot of reactor length. In one or more embodiments, the first FT reactor 100 is operated at a GHSV of about 1000, 1200, or 1500 hs⁻¹.

Continuing to refer to FIG. 2, the first FT hydrocarbon products are separated 230 into first liquid FT products and first gas FT products. The first liquid FT products may be sent 232 to be further processed, and/or to storage and/or transported offsite. The first gas FT products are introduced 240 as at least part of a second synthesis gas feed to a second FT reactor having a second FT catalyst and a second heat transfer surface area to catalyst volume ratio that is different from the first heat transfer surface area to catalyst volume ratio. The first and second FT reactors may otherwise be the same or may different from each other in additional ways. In one or more embodiments of the present disclosure, the dimensions of the first FT reactor and the second FT reactor may be the same or may be different. The first FT reactor may be more resistant to poisoning by contaminants commonly found in a synthesis gas feed than is the second FT reactor. For example, the first FT reactor may be more resistant to poisoning by sulfur compounds, including, but not limited to, hydrogen sulfide. In this way, the first FT reactor may dually serve as an FT production reactor and as a guard bed, protecting the second FT reactor from poisoning. As opposed to conventional guard beds, however, the first FT reactor produces FT products, i.e., the sole purpose of the first FT reactor is not to remove contaminants from a synthesis gas feed. Due to the contaminant reduction provided by first FT reactor, the second FT reactor may be operable with and/or may contain a more expensive catalyst than first FT reactor. In other embodiments, the FT catalyst used in the first and second reactor may be the same. The second FT reactor may also differ from the first FT reactor in other ways as described herein with respect to FIG. 1.

In one or more embodiments, the second synthesis gas feed is comprised solely of the first gas FT products. In one or more embodiments, the second synthesis gas feed is comprised of the first gas FT products and of other inputs for example, as described with respect to FIG. 1.

In the one or more methods of FIG. 2, operating under FT conditions (which may be similar to or dissimilar from the FT operating conditions of the first FT reactor), the second FT reactor produces 250 second FT hydrocarbon products from the second synthesis gas feed. The second FT hydrocarbon products are separated 260 into second liquid FT products and second gas FT products. The second liquid FT products are sent 262 for further processing and/or to storage and/or to be transported offsite. One or more portions of the second gas FT products are recycled 264 to become part of the first synthesis gas feed, and/or the second synthesis gas feed and/or are sent to an additional separator apparatus, such as for example separator 122 of FIG. 1.

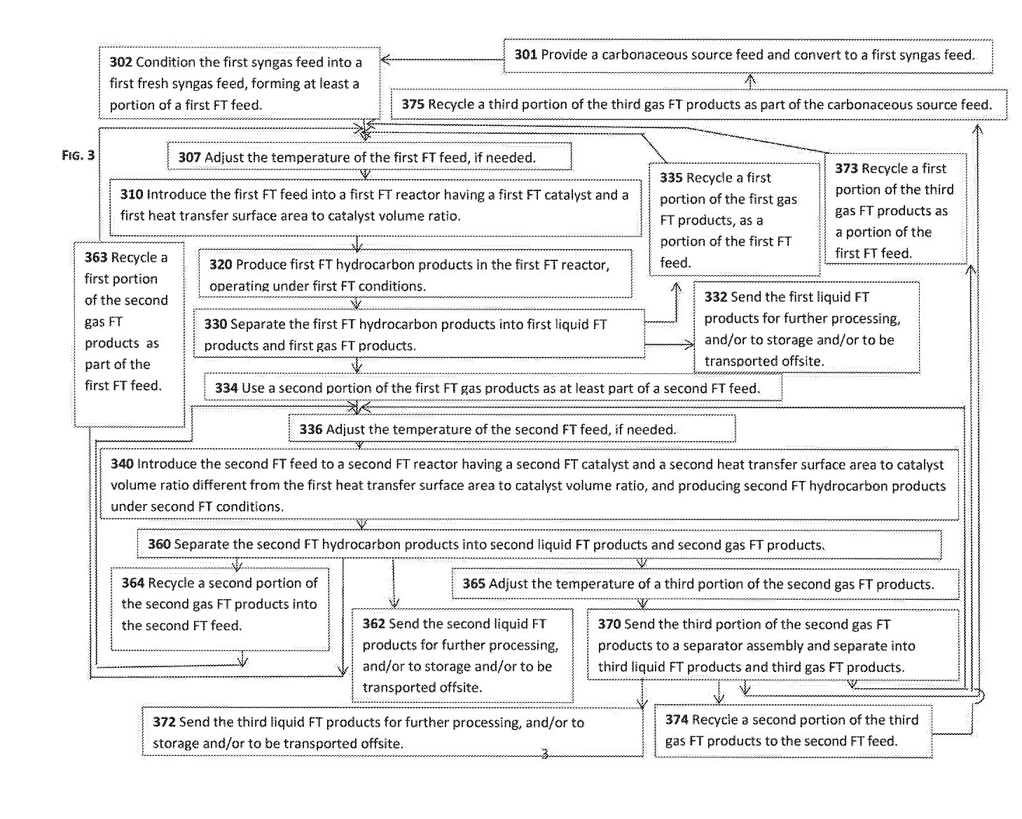

Turning now to FIG. 3, which depicts a flowchart of in one or more embodiments of methods in accordance with the present disclosure, a carbonaceous source feed is provided 301 in one or more methods of the instant disclosure and converted into a first syngas feed. The conversion may be accomplished by one or more methods, as is known in the art, such as through use of a steam reformer, an autothermal reformer, a partial oxidation unit and/or a hybrid unit, each of which could be termed a syngas production apparatus. The synthesis gas produced in synthesis gas production apparatus may comprise one or more components that are undesirable as a component of an FT feed stream. For example, the syngas produced in syngas production apparatus, which may be referred to as “dirty” syngas, may contain an undesirably high level of carbon dioxide, hydrogen sulfide, or some other component. In one or more embodiments, the “dirty” syngas produced in synthesis gas production apparatus comprises at least or about 0.1, 0.5, or 1% volume percent hydrogen sulfide. In one or more embodiments, the “dirty” syngas comprises at least or about 1, 5, or 10 volume percent carbon dioxide. In one or more embodiments, the method further comprises removing at least a portion of at least one undesirable component from the “dirty” syngas.

Accordingly, the first syngas feed may be conditioned 302 into a first fresh syngas feed, which forms at least a part of a first FT feed. For example, the “dirty” synthesis gas from the syngas production apparatus may be introduced into a syngas clean-up apparatus. The dirty syngas may be heated or cooled using a temperature adjuster depending on the type of cleanup system used in the syngas clean-up apparatus. In one or more embodiments, the syngas clean-up apparatus may comprise a first unit to perform a wash step. In such embodiments, the temperature of the dirty syngas would need to be cooled, if the syngas comes to the syngas clean-up apparatus directly from the syngas production apparatus. In one or more embodiments, the first unit of the syngas clean-up apparatus is an acid gas removal unit that operates below room temperatures. In such embodiments, the temperature of the dirty syngas would need to be cooled to a temperature close to the wash stream.

In one or more embodiments, where the carbonaceous source feed includes desulfurized natural gas and the dirty syngas comes from a steam methane reformer, then the dirty syngas may need to be cooled prior to contacting the hydrogen membrane. In one or more other embodiments, the dirty syngas may need to be heated prior to contacting an adsorbent bed, such as a zinc oxide bed. The ‘clean’ synthesis gas extracted from syngas clean-up apparatus may contain less than or about 10, 5, or 1 ppb volume percent hydrogen sulfide. Although indicated as a single apparatus, it is to be understood that syngas clean-up apparatus may comprise more than one unit.

The conditioned first syngas feed forms at least a portion of a first FT feed. The temperature of the first FT feed may be adjusted 307, if needed. The first gas feed is introduced 310 into a first FT reactor having a first FT catalyst and a first heat transfer surface area to catalyst volume ratio. The first FT reactor, operating under FT conditions, produces 320 first FT hydrocarbon products from the first feed. The first FT reactor is operable with a heat transfer apparatus (which may be such as previously discussed with respect to the first steam drum 101 of FIG. 1) configured to maintain a desired reaction temperature, as known in the art.

The first FT hydrocarbon products are separated 330 into first liquid FT products and first gas FT products. The first liquid FT products are sent 332 for further processing, and/or to storage and/or to be transported offsite. A first portion of the first gas FT products may be recycled 335, forming a portion of the first FT feed.

Referring to FIG. 3, a second portion of the first FT gas products are used 334 as at least part of a second FT feed. The temperature of the second FT feed may be adjusted 336, if needed. The second FT feed is introduced 340 to a second FT reactor having a second FT catalyst and a second heat transfer surface area to catalyst volume ratio to produce second FT hydrocarbon products under FT conditions. As discussed above with respect to FIG. 1 and FIG. 2, while the second FT reactor may or may not differ from the first FT reactor in dimension, the second heat transfer surface area to catalyst volume ratio differs from the first second heat transfer surface area to catalyst volume ratio. In one or more embodiments, the second FT reactor is operated to produce second FT hydrocarbon products ranging from methane to high molecular weight hydrocarbons comprising, for example, 100+ carbon atoms. In one or more embodiments, as mentioned hereinabove, the second FT reactor may be operated at a higher conversion of carbon monoxide than the first FT reactor. In one or more embodiments, the second FT reactor is operated at a catalyst productivity greater than about 200, 400, or 600 cc CO converted/cc catalyst/h. In one or more embodiments, operation of the second FT reactor is more closely held to isothermal than is the first FT reactor. In one or more embodiments, the second FT reactor is operated at a higher temperature than the first FT reactor. In one or more embodiments, the first FT reactor is operated at a temperature of less than about 180° C., 200° C., or 220° C., and the second FT reactor 150 is operated at a temperature higher than about 190° C., 210° C., or 230° C. In one or more embodiments, the second FT reactor is operated at a temperature in the range of from about 185° C. to about 235° C., from about 190° C. to about 230° C., or from about 195° C. to about 230° C. In one or more embodiments, the second FT reactor is operated at a pressure in the range of from about 380 psig to about 400 psig, from about 400 psig to about 500 psig, or from about 450 psig to about 500 psig. In one or more embodiments, the second FT reactor is operated with a pressure drop across the reactor of that is greater than the pressure drop across the first FT reactor. In one or more embodiments, the second FT reactor is operated with a pressure drop thereacross that is greater than about 4, 8, or 10 psi/foot of reactor length. In one or more embodiments, the second FT reactor is operated at a GHSV greater than the GHSV at which the first FT reactor is operated. In one or more embodiments, the second FT reactor is operated at a GHSV that is greater than about 1500, 2000, or 3000 hr⁻¹.

Continuing to refer to FIG. 3, the second FT hydrocarbon product produced in the second FT reactor comprises liquid FT hydrocarbons and second FT gas products The second FT gas products comprise unreacted synthesis gas and may further comprise carbon dioxide, and/or low molecular weight hydrocarbons. The second FT products of the second FT reactor may comprise a substantial quantity of high molecular weight hydrocarbons, generally from about C₅ to about C₁₀₀, or larger. The second liquid FT products may comprise a mixture of hydrocarbons that result from the polymerization of a CH₂ block and it follows a growing chain probability (alpha value) between 0.8 and 0.97. The second FT hydrocarbon products produced by the second FT reactor are separated 360 into the second FT liquid products and the second FT gas products. The second liquid FT products may be sent 362 for further processing, and/or to storage and/or to be transported offsite. A first portion of the second gas FT products may be recycled 363 into the first FT feed, as depicted in FIG. 3. A second portion of the second gas FT products may be recycled 364 into the second FT feed. For a third portion of the second gas FT products, the temperature may be adjusted 365, if needed, and the third portion of the second gas FT products may be sent 370 to a separator assembly, to be separated into third liquid FT products and third gas FT products. The third liquid FT products may then be sent 372 for further processing, and/or to storage and/or to be transported offsite. A first portion of the third gas FT products may be recycled 373 to become part of the first FT feed. A second portion of the third gas FT products may be recycled 374 to become part of the second FT feed. A third portion of the third gas FT products may be recycled 375 to an input of the syngas production apparatus or to otherwise be combined with the carbonaceous source feed.

Although recycle of various synthesis gas and FT tail gas stream(s) is described herein, in one or more embodiments, the system and method may be operated as a once-through system and/or method in certain applications. In other applications, recycle of one or more synthesis gas streams (e.g., recycle of synthesis gas from the first separation apparatus 120 to the first FT reactor 100 via the first recycle line 135, recycle of synthesis gas from the second separation apparatus 152 to the first FT reactor 100 via the fourth recycle line 145, recycle of synthesis gas from the second separation apparatus 152 to the second FT reactor 150 via the third recycle line 144) and/or recycle of one or more tail gas streams (e.g., recycle of FT tail gas from the LFTL (or CLFTL) separator 122 to the first FT reactor 100, the second FT reactor 150, and/or the syngas production apparatus 40 via the LFTL separator output line 166) is employed to enhance the overall production of liquid hydrocarbons via the disclosed system and method.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term ‘optionally’ with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims that follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A Fischer-Tropsch (“FT”) reactor system, the system comprising:
a. a first FT reactor having a first FT catalyst and a first heat transfer surface area to catalyst volume ratio, the first FT reactor configured to receive a first feed comprising synthesis gas and, operating at first FT conditions, to convert a first portion of the synthesis gas in the first feed into first FT products comprising FT hydrocarbons and leave unconverted a second portion of the synthesis gas;
b. a first separation apparatus configured to receive the first FT products as at least part of its feed and to separate the first FT products into first liquid FT hydrocarbons and first FT tail gas stream comprising unreacted syngas; and
c. a second FT reactor, having a second FT catalyst and a second heat transfer surface area to catalyst volume ratio that is different from the first heat transfer surface area to catalyst volume ratio, in series with the first FT reactor and configured to receive a second feed comprising the first FT tail gas stream and, operating at second FT conditions, to convert at least a portion of the second feed into a second FT product comprising second liquid FT hydrocarbons and a second FT tail gas stream.

2. The system of claim 1, wherein the first heat transfer surface area to catalyst volume ratio is less than about 8 inch⁻¹ and wherein the second heat transfer surface area to catalyst volume ratio is greater than the first heat transfer surface area to catalyst volume ratio.

3. The system of claim 1, wherein the second heat transfer surface area to catalyst volume ratio is less than about 8 inch⁻¹ and wherein the first heat transfer surface area to catalyst volume ratio is greater than the second heat transfer surface area to catalyst volume ratio.

4. The system of claim 1, wherein the second FT reactor has a lower selectivity of heavy FT products than the first FT reactor has.

5. The system of claim 1, wherein that the first FT reactor is more resistant to poisoning of the first FT catalyst than the second FT reactor is to the poisoning of the second FT catalyst.

6. The system of claim 1, wherein the first FT reactor is operable at a lower productivity than the second FT reactor.

7. The system of claim 1, wherein that the first FT reactor is operable at a lower gas hourly space velocity (GHSV) than the second FT reactor.

8. The system of claim 7, wherein the first FT reactor is configured for operation at a GHSV that is less than or equal to about 1000 h-1, less than or equal to about 1200 h-1, or less than or equal to about 1500 h-1.

9. The system of claim 1, wherein the second FT catalyst has a higher productivity than the first FT catalyst.

10. The system of claim 9, wherein the first FT reactor is configured for operation at a productivity of less than about 300 cubic centimeters of carbon monoxide converted per cubic centimeter of catalyst volume per hour.

11. The system of claim 1, wherein the first FT reactor is configured for operation at a lower temperature than that for which the second FT reactor is configured.

12. The system of claim 1, wherein the first FT reactor is configured for operation at a higher temperature than that for which the second FT reactor is configured.

13. The system of claim 1, wherein the first FT reactor is configured for operation with a pressure drop thereacross that is less than a pressure drop for which the second FT reactor is configured.

14. The system of claim 13, wherein the first FT reactor is operable with a pressure drop per foot of reactor length that is less than about 3 psig per foot.

15. The system of claim 1, wherein the first FT reactor is operable at a water vapor partial pressure that is less than that of the second FT reactor.

16. The system of claim 1, wherein the first FT reactor has a lesser heat transfer surface area per unit catalyst volume than the second FT reactor and is configured to be operate with a lower carbon monoxide conversion level than the second FT reactor, to produce less liquid FT products than the second FT reactor, and to have a lower pressure drop than the pressure drop across the second FT reactor.

17. The system of claim 1, wherein the first FT reactor and the second FT reactor have different dimensions.

18. The system of claim 1, wherein the first FT reactor comprises a tubular FT reactor and the second FT reactor is selected from microchannel FT reactors and compact FT reactors.

19. The system of claim 1, wherein the first FT reactor is selected from the group of microchannel FT reactors and compact FT reactors and the second FT reactor comprises a tubular FT reactor.

20. The system of claim 18, wherein the first FT reactor comprises at least one tube with an average inner cross sectional dimension of greater than about 0.5 Inches.

21. The system of claim 1, further comprising a first gas/liquid separator configured to separate unreacted synthesis gas from one or more other components of the first FT product, wherein the first FT product comprises first FT liquid hydrocarbons and first FT gas comprising unreacted synthesis gas.

22. The system of claim 9, wherein the first FT catalyst is selected from the group consisting of Co/SiO₂ FT catalysts, Co/AlO₃ FT catalysts, Co/TiO₂ FT catalysts, and combinations thereof.

23. The system of claim 9, wherein the second FT catalyst is selected from the group consisting of Co/Ru FT catalysts, Co/Pd FT catalysts, Co/Pt FT catalysts, and combinations thereof.

24. The system of claim 1, wherein the first FT catalyst comprises primarily one or more catalytic metals selected from the group consisting of cobalt, ruthenium, and nickel.

25. The system of claim 24, wherein the second FT catalyst comprises primarily one or more catalytic metals selected from the group consisting of cobalt, ruthenium, and nickel.

26. The system of claim 1, further comprising:
a. a second separation apparatus configured to receive the second FT products as at least part of its feed and to separate the second FT products into second liquid FT hydrocarbons and a second FT tail gas stream; and
b. a first recycle line configured to introduce at least a portion of the a second FT tail gas stream as a component of the first feed or the second feed or both,

27. The system of claim 26, wherein the system further comprises:
a. a cooler;
b. a gas/liquid separator downstream of the cooler;
c. a flowline configured to convey a portion of the second FT tail gas stream to the cooler and thence to the gas/liquid separator, which is configured to separate unreacted synthesis gas from at least one other component of the second FT tail gas.

28. A method of producing FT hydrocarbons, the method comprising:
a. introducing a first syngas feed comprising carbon monoxide and hydrogen into a first FT reactor having a first FT catalyst and a first heat transfer surface area to catalyst volume ratio;
b. operating the first FT reactor at first FT operating conditions to convert a first portion of the syngas in the first syngas feed to first FT product hydrocarbons, leaving a second portion of the syngas in the first syngas feed unconverted;
c. separating the first FT product hydrocarbons into a first FT tail gas stream comprising the unconverted second portion of the syngas and into first liquid FT product hydrocarbons;
d. introducing a second syngas feed comprising the first FT tail gas stream including the second portion of the syngas into a second FT reactor having a second FT catalyst and a second heat transfer surface area to catalyst volume ratio different from the first heat transfer surface area to catalyst volume ratio; and
e. operating the second FT reactor at second FT operating conditions to convert at least a portion of the syngas in the second feed to second FT product hydrocarbons.

29. The method of claim 28, wherein the first FT reactor and the second FT reactor have the same dimensions.

30. The method of claim 28, wherein the second FT operating conditions are different from the first FT operating conditions.

31. The method of claim 28, wherein the first FT reactor is selected from tubular FT reactors.

32. The method of claim 31, wherein the second FT reactor is selected from the group consisting of microchannel FT reactors and compact FT reactors.

33. The method of claim 28, wherein the first FT reactor is selected from the group consisting of microchannel FT reactors and compact FT reactors.

34. The method of claim 28, wherein the first heat transfer surface area to catalyst volume ratio is less than about 8 inch⁻¹ and wherein the second heat transfer surface area to catalyst volume ratio is greater than the first heat transfer surface area to catalyst volume ratio.

35. The method of claim 28, wherein the second FT reactor has a lower selectivity of heavy FT products than the first FT reactor has.

36. The method of claim 28, wherein the first FT reactor is more resistant to poisoning of the first FT catalyst than the second FT reactor is to poisoning of the second FT catalyst.

37. The method of claim 28, wherein the first FT reactor operates at a lower productivity than the second FT reactor.

38. The method of claim 28, wherein the first FT reactor operates at a lower gas hourly space velocity (GHSV) than the second FT reactor.

39. The method of claim 38, wherein the first FT reactor operates at a GHSV that is less than or equal to about 1000 h-1, less than or equal to about 1200 h-1, or less than or equal to about 1500 h-1.

40. The method of claim 28, wherein the second FT catalyst has a higher productivity than the first FT catalyst.

41. The method of claim 40, wherein the first FT reactor operates at a productivity of less than about 300 cubic centimeters of carbon monoxide converted per cubic centimeter of catalyst volume per hour.

42. The method of claim 28, wherein the first FT reactor operates at a lower temperature than the temperature at which the second FT reactor operates.

43. The method of claim 28, wherein the first FT reactor operates at a temperature in the range of from about 160° C. to about 230° C., from about 190° C. to about 230° C., or from about 180° C. to about 190° C.

44. The method of claim 28, wherein the first FT reactor operates with a pressure drop thereacross that is less than the pressure drop across the operating second FT reactor.

45. The method of claim 44, wherein the first FT reactor operates with a pressure drop per foot of reactor length that is less than about 3 psig per foot.

46. The method of claim 28, wherein the at least one way other than dimension that the second FT reactor differs from the first FT reactor includes that the first FT reactor is operable at a water vapor partial pressure that is less than that of the second FT reactor.

47. The method of claim 28, wherein the first FT reactor has a lesser heat transfer surface area per unit catalyst volume than the second FT reactor and operates with a lower carbon monoxide conversion level than the second FT reactor, producing less liquid FT products than the second FT reactor, with a lower pressure drop than a pressure drop across the operating second FT reactor.

48. The method of claim 28, further comprising:
a. separating the second FT product hydrocarbons into a second FT tail gas stream comprising the unconverted second portion of the syngas and into second liquid FT product hydrocarbons;
b. wherein the first syngas feed comprises fresh synthesis gas and optionally further comprises at least a portion of the first FT tail gas; at least a portion of the second FT tail gas, or both; and wherein the method further comprises maintaining a molar ratio of hydrogen to carbon monoxide in the first syngas feed at a value in the range of from about 1.6:1 to about 2.1:1.

49. The method of claim 48, further comprising operating the first FT reactor such that the at least a portion of the unconverted second portion of the syngas from the first FT reactor has a molar ratio of hydrogen to carbon monoxide that is greater than or equal to about 0.7:1.

50. The method of claim 48, wherein the second syngas feed further comprises fresh synthesis gas, at least a portion of the second FT tail gas, or both; and wherein the method further comprises maintaining a molar ratio of hydrogen to carbon monoxide in the second syngas feed at a value in the range of from about 1.6:1 to about 2.1:1.

51. The method of claim 28, wherein the first FT reactor, the second FT reactor, or both are fixed bed reactors.

52. The method of claim 28, wherein the first FT reactor is a fixed bed reactor comprising a FT catalyst comprising primarily one or more catalytic metals selected from the group consisting of cobalt, ruthenium, and nickel.

53. The method of claim 51, wherein the second FT reactor is a fixed bed reactor comprising a FT catalyst comprising primarily one or more catalytic metals selected from the group consisting of cobalt, ruthenium, and nickel.

54. The method of claim 51, wherein the first FT catalyst and the second FT catalyst are each selected from the group consisting of cobalt-based FT catalysts.

55. The method of claim 54, wherein the first FT catalyst is selected from the group consisting of Co/SiO₂ FT catalysts, Co/TiO₂ FT catalysts, Co/Al₂O₃ FT catalysts, and combinations thereof.

56. The method of claim 54, wherein the second FT catalyst is selected from the group consisting of Co/Ru FT catalysts, Co/Pd FT catalysts, Co/Pt FT catalysts, and combinations thereof.

57. The method of claim 28, wherein the second FT reactor is a fixed bed reactor comprising a FT catalyst comprising primarily one or more catalytic metals selected from the group consisting of cobalt, ruthenium, and nickel.

58. The method of claim 28, further comprising operating the first FT reactor such that the unreacted synthesis gas in the first FT tail gas stream has a molar ratio of hydrogen to carbon monoxide that is greater than or equal to about 0.7:1.

59. The method of claim 28, further comprising recycling at least a portion of the first FT tail gas stream into the first FT reactor as a portion of the first syngas feed.

60. The method of claim 58, further comprising;
a. cooling at least a portion of the second FT tail gas stream;
b. separating unreacted synthesis gas from the cooled at least a portion of the second FT tail gas.

61. The method of claim 60, further comprising recycling at least a portion of the cooled at least a portion of the second FT tail gas stream as a portion of the second synthesis gas feed, or as as a portion of the first syngas feed, or both.

62. The method of claim 59, comprising both recycling at least a portion of the synthesis gas separated from the product extracted from the second FT reactor into the second FT reactor as a portion of the second syngas feed, and recycling at least another portion of the synthesis gas separated from the product extracted from the second FT reactor into the first FT reactor as a portion of the first syngas feed.

63. The method of claim 28, further comprising operating the second FT reactor such that the unreacted synthesis gas in the second FT tail gas stream has a molar ratio of hydrogen to carbon monoxide that is greater than or equal to about 0.8:1.

64. The method of claim 28, wherein the first syngas feed comprises greater than about 100 ppb sulfur-containing components.

65. The method of claim 64, wherein the second syngas feed comprises less than about 10 ppb sulfur-containing components.

66. A method of producing FT hydrocarbons, the method comprising:
a. providing a carbonaceous source feed and converting the carbonaceous source feed to a first syngas feed;
b. conditioning the first syngas feed into a first fresh syngas feed, forming at least a portion of a first FT feed;
c. adjusting the temperature of the first FT feed;
d. introducing the first FT feed into a first FT reactor stage comprising one or a plurality of FT reactors each having a first FT catalyst and a first heat transfer surface area to catalyst volume ratio;
e. producing first FT hydrocarbon products in the first FT reactor stage operating under first FT operating conditions;
f. separating the first FT hydrocarbon products into first liquid FT products and a first gas FT product stream;
g. recycling a first portion of the first gas FT product stream as a portion of the first feed;
h. using a second portion of the first gas FT product stream as at least part of a second FT feed;
i. adjusting the temperature of the second FT feed;
j. introducing the second FT feed having the adjusted temperature to a second FT reactor stage comprising one or a plurality of FT reactors each having a second FT catalyst and a second heat transfer surface area to catalyst volume ratio wherein a first ratio of the combined heat transfer surface area of all of the first FT reactors of the first FT reactor stage divided by the total combined catalyst volume of all of the first FT reactors of the first FT reactor stage differs from a second ratio of the combined heat transfer surface area of all of the second FT reactors of the second FT reactor stage divided by the total combined catalyst volume of all of the second FT reactors of the second FT reactor stage;
k. operating the second FT reactor stage at second FT operating conditions to convert at least a portion of the syngas in the second feed to second FT product hydrocarbons;
l. separating the second FT hydrocarbon products into second liquid FT products and a second gas FT product stream;
m. recycling a first portion of the second gas FT product stream as part of the first FT feed;
n. recycling a second portion of the second gas FT product stream as part of the second FT feed;
o. adjusting the temperature of a third portion of the second gas FT product stream;
p. separating the third portion of the temperature-adjusted second gas FT product stream into third liquid FT products and a third gas FT product stream;
q. recycling a first portion of the third gas FT product stream as part of the first FT feed;
r. recycling a second portion of the third gas FT product stream as part of the second FT feed; and
s. recycling a third portion of the third gas FT product stream as part of the carbonaceous source feed.

67. A method of claim 66, wherein the first FT reactor stage comprises a plurality of FT reactors in parallel.

68. A method of claim 66, wherein the first FT reactor stage comprises a plurality of FT reactors in series.

69. A method of claim 66, wherein the second FT reactor stage comprises a plurality of FT reactors in parallel.

70. A method of claim 66, wherein the second FT reactor stage comprises a plurality of FT reactors in series.

71. An apparatus comprising:
a. a Fischer-Tropsch (“FT”) reactor having a first FT catalyst and a first heat transfer surface area to catalyst volume ratio and being configured to receive a first feed comprising synthesis gas and to convert a first portion of the synthesis gas in the first feed into first FT products comprising FT hydrocarbons and leave unconverted a second portion of the synthesis gas and further configured to provide the unconverted second portion of the synthesis gas to a second FT reactor having a second FT catalyst and a second heat transfer surface area to catalyst volume ratio which is different from the first heat transfer surface area to catalyst volume ratio.

72. An apparatus comprising:
a. a Fischer-Tropsch (“FT”) reactor having a first FT zone configured to provide a first heat transfer surface area to catalyst volume ratio and a second FT zone configured to provide a second heat transfer surface area to catalyst volume that is different from the heat transfer surface area to catalyst volume ratio of the first zone, wherein
i. the first FT zone has a first FT catalyst and is configured to receive a first feed comprising synthesis gas and to operate under first FT conditions to convert a first portion of the synthesis gas in the first feed into first FT products and leave unconverted a second portion of the synthesis gas and further configured to provide the unconverted second portion of the synthesis gas as at least a portion of a second feed to the second FT zone; and
ii. the second FT zone has a second FT catalyst and is configured to receive the second feed and to operate under second FT conditions to convert unconverted synthesis gas in the second feed into second FT products.
